(19) United States
(12) Patent Application Publication
(10) Pub. No.: US 2021/0246338 A1
(43) Pub. Date: Aug. 12, 2021

(54) ADHESIVE SHEET, OPTICAL FILM WITH ADHESIVE LAYER, MULTILAYER BODY AND IMAGE DISPLAY DEVICE

(71) Applicant: NITTO DENKO CORPORATION, Ibaraki-shi, Osaka (JP)

(72) Inventors: Shou TAKARADA, Ibaraki-shi, Osaka (JP); Taiki SHIMOKURI, Ibaraki-shi, Osaka (JP); Minako NODA, Ibaraki-shi, Osaka (JP)

(73) Assignee: NITTO DENKO CORPORATION, Ibaraki-shi, Osaka (JP)

(21) Appl. No.: 17/053,875

(22) PCT Filed: Jan. 20, 2020
(86) PCT No.: PCT/JP2020/001741

§ 371 Date: Nov. 9, 2020

(30) Foreign Application Priority Data
Jan. 30, 2019 (JP) 2019-014731
Jan. 17, 2020 (JP) 2020-006388

(51) Int. Cl. C09J 7/38; G02B 5/30; C09J 7/40; C09J 133/06; C09J 133/08

(52) U.S. Cl. CPC C09J 7/385; G02B 5/30; C09J 7/40; C09J 2301/124; C09J 133/08; C09J 2433/00; C09J 133/066

(57) ABSTRACT

A pressure sensitive adhesive sheet (11) according to the present invention contains an acryl-based base polymer having a crosslinked structure, and an acryl-based oligomer having a glass transition temperature of 60° C. or higher. The pressure sensitive adhesive sheet has a storage elastic modulus G′₂₅ of 5 to 75 kPa at 25° C. and 1 Hz, a loss tangent tan δ₂₅ of 0.2 to 0.45 at 25° C. and 1 Hz, a loss tangent tan δ₁₀₀ of 0.2 to 0.45 at 100° C. and 1 Hz, a difference between the tan 625 and the tan δ₁₀₀ of −0.09 to 0.09, and a glass transition temperature of −15° C. or lower.

### TECHNICAL FIELD

The present invention relates to a pressure sensitive adhesive sheet which is suitably used for bonding members in a bendable image display device. Further, the present invention relates to a laminate body in which the pressure sensitive adhesive sheet and a flexible member are laminated; and an image display device including the pressure sensitive adhesive sheet.

### BACKGROUND ART

Flat panel displays such as liquid crystal displays and OLED displays are used as image display devices such as mobile phones, smartphones, tablet terminals, car navigation devices, monitors for personal computers, and televisions. In recent years, OLED panels including bendable substrates (flexible substrates) such as resin films have been put into practical use, and a bendable flexible display has been proposed.

In a flexible display, a display panel such as an OLED panel is bendable, constituent members such as a housing, a touch panel and a cover window are also bendable, and these members are bonded together with a pressure sensitive adhesive sheet interposed between the members (e.g., Patent Document 1). A foldable flexible display (foldable display) is repeatedly bent at the same position. At the bending position, compressive stress is applied on the inside, and tensile stress is applied on the outside, so that strain occurs at the bending position and the periphery thereof. Therefore, there is a concern that the device is broken. Thus, it has been proposed that a pressure sensitive adhesive sheet for bonding members be softened to relax stress strain (e.g., Patent Document 2).

### PRIOR ART DOCUMENTS

### Patent Documents

Patent Document 1: Japanese Patent Laid-open Publication No. 2016-2764
Patent Document 2: Japanese Patent Laid-open Publication No. 2018-45213

### SUMMARY OF THE INVENTION

### Problems to be Solved by the Invention

Generally, when a pressure sensitive adhesive is softened for imparting a stress relaxation property, adhesive strength tends to decrease because cohesive force of a base polymer forming the pressure sensitive adhesive, and repetition of bending may cause a pressure sensitive adhesive sheet to peel from an adherend at the bending position and the periphery thereof. In addition, in a flexible display, most of members such as a housing, a display panel substrate, a touch panel substrate and a cover window are made of resin materials, and therefore outgas is easily generated in a high-temperature environment. When the pressure sensitive adhesive sheet is soft, the outgas generated from the resin materials in a high-temperature environment may remain as bubbles at the bonding interface with the pressure sensitive adhesive sheet, resulting in deterioration of visibility and peeling between the members.

In view of the above-described circumstances, an object of the present invention is to provide a pressure sensitive adhesive sheet which has both flexibility and high adhesive strength, and a resisting force against a pressure causing release of outgas from resin members and the like, and is suitably used for bonding between members of a flexible display.

### Means for Solving the Problems

The pressure sensitive adhesive sheet of the present invention is a sheet-shaped pressure sensitive adhesive whose main component is an acryl-based base polymer having a crosslinked structure. The crosslinked structure of the acryl-based base polymer can be introduced by, for example, reaction of a crosslinker such as an isocyanate-based crosslinker or a polyfunctional polymerizable compound such as a polyfunctional (meth)acrylate.

In a pressure sensitive adhesive sheet in an embodiment, the storage elastic modulus at 25° C. and 1 Hz (G′₂₅) is 5 to 75 kPa, the loss tangent at 25° C. and 1 Hz (tan 625) is 0.2 to 0.45, the loss tangent at 100° C. and 1 Hz (tan δ₁₀₀) is 0.2 to 0.45, and the difference between tan δ₂₅ and tan δ₁₀₀ is −0.09 to 0.09. The storage elastic modulus at 100° C. and 1 Hz (G′₁₀₀) of the pressure sensitive adhesive sheet is preferably 3 to 50 kPa. The glass transition temperature of the pressure sensitive adhesive sheet is preferably −15° C. or lower.

The thickness of the pressure sensitive adhesive sheet is preferably 10 to 150 μm. The adhesive strength of the pressure sensitive adhesive sheet to a polyimide film is preferably 2.7 N/10 mm or more. The gel fraction of the pressure sensitive adhesive sheet is preferably 55 to 85%.

The acryl-based base polymer contains a (meth)acrylic acid alkyl ester as a main constituent monomer component. In an embodiment, the acryl-based base polymer is a copolymer containing 30 to 70 parts by weight of a (meth)acrylic acid C₁₀₋₂₀ chain alkyl ester, 15 to 60 parts by weight of a (meth)acrylic acid C₁₋₉ chain alkyl ester and 5 to 25 parts by weight of one or more polar group-containing monomers selected from the group consisting of a hydroxy group-containing monomer, a carboxy group-containing monomer and a nitrogen-containing monomer, based on 100 parts by weight of the total of monomer components.

The (meth)acrylic acid C₁₀₋₂₀ chain alkyl ester is preferably lauryl acrylate. Preferably, the acryl-based base polymer contains a hydroxy group-containing monomer and a nitrogen-containing monomer as polar group-containing monomers in the monomer components.

The pressure sensitive adhesive sheet may contain an oligomer in addition to the above-described acryl-based base polymer, which is preferably an acryl-based oligomer having a glass transition temperature of 60° C. or higher. From the viewpoint of achieving both high adhesiveness and transparency, the content of the acryl-based oligomer is preferably 0.5 to 10 parts by weight based on 100 parts by weight of the acryl-based base polymer.

The pressure sensitive adhesive sheet can be used for bonding two bendable members in a bendable image display device (flexible display). For example, the pressure sensitive adhesive sheet is disposed between a bendable image display panel and a bendable cover window.

In an embodiment, the pressure sensitive adhesive sheet is used for bonding a cover window. For example, in a flexible display including a bendable image display panel, a bendable cover window, and a polarizing plate between the image display panel and the cover window, the polarizing plate and the cover window may be bonded to each other with the pressure sensitive adhesive sheet interposed therebetween.

The pressure sensitive adhesive sheet can be provided as a release film-equipped pressure sensitive adhesive sheet in which a release film is temporarily attached on both sides. In addition, a pressure sensitive adhesive layer-equipped optical film may be formed in which the pressure sensitive adhesive sheet is laminated on at least one side of an optical film such as a polarizing plate. The pressure sensitive adhesive layer-equipped optical film may have a pressure sensitive adhesive sheet laminated on both sides of the optical film.

In the both sides pressure sensitive adhesive layer-equipped optical film, which has a pressure sensitive adhesive sheet disposed on an optical film, one pressure sensitive adhesive sheet may be the same as or different from the other pressure sensitive adhesive sheet. In the both sides pressure sensitive adhesive layer-equipped optical film, one pressure sensitive adhesive sheet may be the above-described pressure sensitive adhesive sheet, or each of both the pressure sensitive adhesive sheets may be the above-described pressure sensitive adhesive sheet.

### Effects of the Invention

The pressure sensitive adhesive sheet of the present invention has both flexibility and high adhesive strength, and has a resisting force against a pressure causing release of outgas from resin members and the like, so that it is suitably used for bonding between members of a flexible display. By bonding flexible members with the pressure sensitive adhesive sheet of the present invention interposed therebetween, peeling of the pressure sensitive adhesive sheet and retention of bubbles at the bonding interface are suppressed even when bending is repeated or the bending state is maintained for a long time.

### BRIEF DESCRIPTION OF THE DRAWINGS

FIG. 1 is a sectional view showing an example of a configuration of a release film-equipped pressure sensitive adhesive sheet.

FIG. 2 is a sectional view showing an example of a configuration of an image display device.

FIG. 3 is a sectional view of a sized piece of release film-equipped pressure sensitive adhesive sheet.

FIG. 4 is a sectional view of a sized piece of release film-equipped pressure sensitive adhesive sheet.

FIG. 5 is a sectional view showing an example of stacking configuration of a pressure sensitive adhesive sheet-equipped optical film.

FIG. 6 is a sectional view showing an example of stacking configuration of a pressure sensitive adhesive sheet-equipped optical film.

FIG. 7 is a sectional view of a laminate in which a plurality of flexible members are laminated and integrated with pressure sensitive adhesive sheets interposed between the flexible members.

FIG. 8 is a sectional view of a laminate in which a plurality of flexible members are laminated and integrated with pressure sensitive adhesive sheets interposed between the flexible members.

### MODE FOR CARRYING OUT THE INVENTION

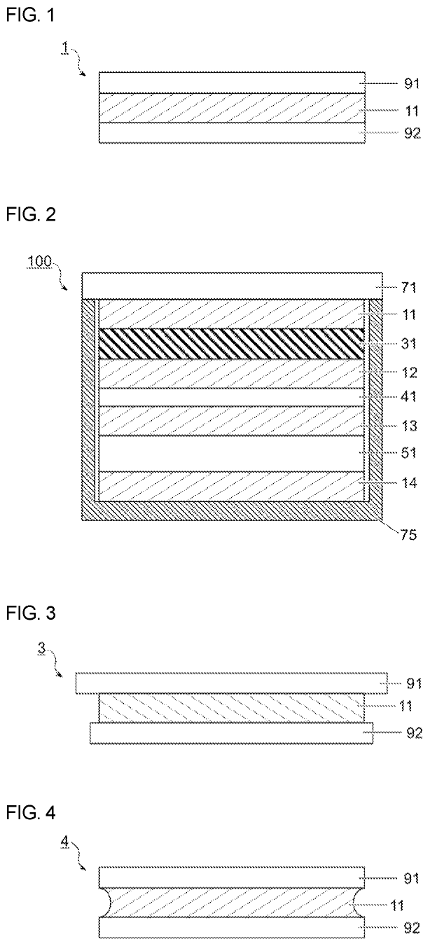

FIG. 1 is a sectional view showing a release film-equipped pressure sensitive adhesive sheet in which release films 91 and 92 are temporarily attached, respectively, to both surfaces of a pressure sensitive adhesive sheet 11. FIG. 2 is a sectional view of a configuration of a flexible display in which an OLED panel 51, a touch panel 41 and a circularly polarizing plate 31 are disposed between a housing 75 and a cover window 71. The OLED panel 51 and the bottom surface of the housing 75 are bonded to each other with a pressure sensitive adhesive sheet 14 interposed therebetween, the OLED panel 51 and the touch panel 41 are bonded to each other with a pressure sensitive adhesive sheet 13 interposed therebetween, the touch panel 41 and the circularly polarizing plate 31 are bonded to each other with a pressure sensitive adhesive sheet 12 interposed therebetween, and the circularly polarizing plate 31 and the cover window 71 are bonded to each other with a pressure sensitive adhesive sheet 11 interposed therebetween. Thus, in a flexible display, a plurality of members are laminated and integrated by bonding the members with pressure sensitive adhesive sheets interposed therebetween.

[Properties of Pressure Sensitive Adhesive Sheet]

The pressure sensitive adhesive sheet 11 is an acryl-based pressure sensitive adhesive sheet formed of a sheet-shaped pressure sensitive adhesive composition whose main component is an acryl-based base polymer. A crosslinked structure is introduced into the acryl-based base polymer. Preferably, the pressure sensitive adhesive composition contains an acryl-based oligomer having a high glass transition temperature (Tg), in addition to the acryl-based base polymer having a crosslinked structure.

In the pressure sensitive adhesive sheet, the storage elastic modulus at 25° C. (G′₂₅) is preferably 10 to 75 kPa. When G′₂₅ is 10 kPa or more, processability and an adhesion retaining force can be secured. When G′₂₅ is 75 kPa or less, strain in bending of a device tends to be relaxed, so that it is possible to suppress damage to device constituent members in repetition of bending. From the viewpoint of attaining both the processability and adhesion retaining force and the strain relaxation property, G′₂₅ of the pressure sensitive adhesive sheet is preferably 15 to 70 kPa, more preferably 20 to 60 kPa, further preferably 25 to 50 kPa.

Preferably, the pressure sensitive adhesive sheet maintains the adhesion retaining force and the stress relaxation property even in a high-temperature environment. Thus, the storage elastic modulus at 100° C. (G′₁₀₀) of the pressure sensitive adhesive sheet is preferably 3 to 50 kPa, more preferably 5 to 40 kPa, further preferably 8 to 30 kPa, especially preferably 10 to 25 kPa.

In the pressure sensitive adhesive sheet, the loss tangent at 25° C. (tan δ₂₅) is preferably 0.2 to 0.45, and the loss tangent at 100° C. (tan δ₁₀₀) is preferably 0.2 to 0.45. In addition, the difference between tan δ₂₅ and tan δ₁₀₀ is preferably −0.09 to 0.09.

The storage elastic modulus G′, and the loss tangent tan δ of the pressure sensitive adhesive sheet are determined by measurement of viscoelasticity at a frequency of 1 Hz. The tan δ is a ratio G″/G′ between the storage elastic modulus G′ and the loss elastic modulus G″. The storage elastic modulus G′ corresponds to a part stored as elastic energy in deformation of a material, and is an index indicating a degree of hardness. As described above, when G′₂₅ is 75 kPa or less, the pressure sensitive adhesive sheet is soft, so that strain can be relaxed.

The loss elastic modulus G″ corresponds to a loss energy part scattered and lost by internal friction etc. in deformation of a material, and indicates the degree of viscidity. As the tan δ represented by G″/G′ increases, the pressure sensitive adhesive sheet tends to become more viscous, and exhibit a deformation behavior closer to that of liquid, leading to a decrease in rebound elastic energy.

It is preferable that tan δ is relatively large for imparting adhesiveness and the strain relaxation property to the pressure sensitive adhesive sheet while securing the adhesion retaining force and processability of the pressure sensitive adhesive sheet. If the tan δ of the pressure sensitive adhesive sheet is excessively small, the adhesive strength is insufficient because the viscosity is small, and peeling may occur at the bending position and the periphery thereof when the pressure sensitive adhesive sheet is held in a bent state for a long time. On the other hand, when the tan δ of the pressure sensitive adhesive sheet is excessively large, plastic deformation of the pressure sensitive adhesive sheet tends to easily occur, leading to insufficiency of the adhesion retaining force. In addition, large tan δ results in decrease of resisting force against a releasing pressure of outgas from an adherend decreases, and therefore when the image display device is exposed to a high-temperature environment for a long time, bubbles generated due to outgas are likely to remain at the bonding interface.

As described above, the tan δ₂₅ and the tan δ₁₀₀ of the pressure sensitive adhesive sheet are each preferably 0.2 to 0.45 for the pressure sensitive adhesive sheet to have adhesive strength, an adhesion retaining force and a resistance to outgas over a wide temperature range. The tan δ₂₅ and the tan δ₁₀₀ are each more preferably 0.25 to 0.40, further preferably 0.28 to 0.38.

In addition, for maintaining the adhesion retaining force over a wide temperature range, the temperature dependency of tan δ is preferably small in the temperature range of about 0 to 100° C., and as described above, the difference between tan δ₂₅ and tan δ₁₀₀ is preferably within 0.09. The difference between tan δ₂₅ and tan δ₁₀₀ is preferably −0.08 to 0.08, more preferably −0.07 to 0.07, further preferably −0.06 to 0.06. The difference between tan δ₂₅ and tan δ₁₀₀ may be within 0.05, within 0.04 or within 0.03.

For reducing the temperature dependency of tan δ in a range from room temperature to a high temperature as described above, the glass transition temperature of the pressure sensitive adhesive sheet is preferably −15° C. or lower, more preferably −20° C. or lower, further preferably −25° C. or lower. The glass transition temperature is a temperature at which tan δ is maximum (peak-top temperature). The temperature dependency of tan δ is large near the glass transition temperature. When the glass transition temperature is sufficiently lower than the device operating environment temperature, the temperature dependency of tan δ in the operating environment temperature range is small. In addition, when the glass transition temperature is in the above-described range, peeling from an adherend at a low temperature can be suppressed because the pressure sensitive adhesive sheet has an adhesion retaining force even in a low-temperature range.

For reducing the temperature dependency of tan δ in the pressure sensitive adhesive sheet, it is preferable that not only the glass transition temperature is set within the above-described range, but also monomer components that form the acryl-based base polymer are adjusted as described later. For example, when a (meth)acrylic acid alkyl ester having a long-chain alkyl group with the alkyl group having 10 or more carbon atoms is used as a monomer component, the temperature dependency of tan δ tends to be small.

The lower limit of the glass transition temperature of the pressure sensitive adhesive sheet is not particularly limited, and is generally −80° C. or higher. When the glass transition temperature is excessively low, the pressure sensitive adhesive sheet tends to have an insufficient adhesion retaining force, and therefore the glass transition temperature of the pressure sensitive adhesive sheet is preferably −80° C. or higher, more preferably −60° C. or higher. The glass transition temperature of the pressure sensitive adhesive sheet may be −50° C. or higher, −45° C. or higher, −40° C. or higher or −38° C. or higher.

The adhesive strength of the pressure sensitive adhesive sheet is preferably 2.7 N/10 mm or more, more preferably 2.8 N/10 mm or more, further preferably 3 N/10 mm or more. The adhesive strength is determined by a peeling test conducted at a peeling speed of 60 mm/minute and a peeling angle of 180° with a polyimide film used as an adherend. Unless otherwise specified, the adhesive strength is a measured value at 25° C. When the adhesive strength of the pressure sensitive adhesive sheet is within the above-described range, it is possible to prevent peeling of the pressure sensitive adhesive sheet from the adherend in repetition of bending.

The thickness of the pressure sensitive adhesive sheet is not particularly limited, and may be appropriately set according to the type of an adherend, and a position at which the pressure sensitive adhesive sheet is disposed in the device (stacking configuration). From the viewpoint of increasing the adhesive strength of the pressure sensitive adhesive sheet, the thickness is preferably 10 μm or more. The thickness of the pressure sensitive adhesive sheet is preferably 150 μm or less, more preferably 125 μm or less, further preferably 100 μm or less, from the viewpoint of suppressing protrusion of the pressure sensitive adhesive from the end surface during processing of the pressure sensitive adhesive sheet, bending of the device, or the like.

Preferably, a pressure sensitive adhesive sheet arranged on the viewing-side from the image display panel 51, like the pressure sensitive adhesive sheets 11, 12 and 13 of the device shown in FIG. 2, has high transparency. The total light transmittance of the pressure sensitive adhesive sheet arranged on the viewing-side is preferably 85% or more, more preferably 90% or more, further preferably 91% or more. The haze of the pressure sensitive adhesive sheet arranged on the viewing-side is preferably 1.5% or less, more preferably 1% or less, further preferably 0.7% or less, especially preferably 0.5% or less.

[Composition of Pressure Sensitive Adhesive Sheet and Method for Preparation Thereof]

The pressure sensitive adhesive sheet of the present invention contains an acryl-based base polymer having a crosslinked structure. Since the acryl-based base polymer is crosslinked, a high adhesion retaining force can be exhibited even when G′ is small and the pressure sensitive adhesive sheet is soft.

<Acryl-Based Base Polymer>

The acryl-based base polymer contains a (meth)acrylic acid alkyl ester as a main constituent monomer component. In this specification, the “(meth)acryl” means acryl and/or methacryl.

As the (meth)acrylic acid alkyl ester, a (meth)acrylic acid C₁₋₂₀ alkyl ester with the alkyl group having 1 to 20 carbon atoms is preferably used. The alkyl group of the (meth)acrylic acid alkyl ester may have a branch or may have a cyclic alkyl group.

Specific examples of the (meth)acrylic acid chain alkyl ester include C₁₋₉ chain alkyl ester such as methyl (meth)acrylate, ethyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, neopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate and isononyl (meth)acrylate; and C₁₀₋₂₀ chain alkyl ester such as decyl (meth)acrylate, isodecyl (meth)acrylate, undecyl (meth)acrylate, dodecyl (meth)acrylate, isotridodecyl (meth)acrylate, tetradecyl (meth)acrylate, isotetradecyl (meth)acrylate, pentadecyl (meth)acrylate, cetyl (meth)acrylate, heptadecyl (meth)acrylate, octadecyl (meth)acrylate, isooctadecyl (meth)acrylate and nonadecyl (meth)acrylate.

Specific examples of the (meth)acrylic acid alkyl ester having a cycloaliphatic alkyl group include (meth)acrylic acid cycloalkyl esters such as cyclopentyl (meth)acrylate, cyclohexyl (meth)acrylate, cycloheptyl (meth)acrylate and cyclooctyl (meth)acrylate; (meth)acrylic acid esters having a dicyclic aliphatic hydrocarbon ring, such as isobornyl (meth)acrylate; and (meth)acrylic acid esters having a tri-or-more-cyclic aliphatic hydrocarbon ring, such as dicyclopentanyl (meth)acrylate, dicyclopentanyloxyethyl (meth)acrylate, tricyclopentanyl (meth)acrylate, 1-adamantyl (meth)acrylate, 2-methyl-2-adamantyl (meth)acrylate and 2-ethyl-2-adamantyl (meth)acrylate.

The amount of the (meth)acrylic acid alkyl ester in the acryl-based base polymer is preferably 60 to 100 parts by weight, more preferably 70 to 95 parts by weight, further preferably 75 to 92 part by weight based on 100 parts by weight of the total monomer components.

Preferably, the acryl-based base polymer contains a (meth)acrylic acid C₁₀₋₂₀ chain alkyl ester as a (meth)acrylic acid alkyl ester. The homopolymer of a (meth)acrylic acid alkyl ester having a long-chain alkyl group having 10 or more carbon atoms has a temperature region (plateau region) which is above Tg and over which the temperature dependency of viscoelasticity is small. Thus, when the base polymer contains a (meth)acrylic acid long-chain alkyl ester as a monomer component, the temperature dependency of tan δ tends to be small.

Among (meth)acrylic acid C₁₀₋₂₀ chain alkyl esters, (meth)acrylic acid C₁₀₋₁₆ alkyl esters are preferable, and (meth)acrylic acid C₁₀₋₁₃ alkyl esters are more preferable, because the temperature range of the plateau region is wide, and the storage elastic modulus in the plateau region is small. Of these, (meth)acrylic acid C₁₂ alkyl esters are preferable, and dodecyl acrylate (lauryl acrylate) is particularly preferable.

While a polymer of a (meth)acrylic acid long-chain alkyl ester has a wide temperature range of the plateau region and a small storage elastic modulus in the plateau region, the polymer has high crystallinity and a high glass transition temperature. For example, a homopolymer of lauryl acrylate has a glass transition temperature of 0° C. For lowering the glass transition temperature of the base polymer, it is preferable that as a monomer component, a (meth)acrylic acid C₁₋₉ chain alkyl ester is present in addition to a (meth)acrylic acid C₁₀₋₂₀ chain alkyl ester.

Among (meth)acrylic acid C₁₋₉ chain alkyl esters, those having a glass transition temperature of −40° C. or lower are preferable for lowering the Tg of the base polymer. Specific examples of the (meth)acrylic acid C₁₋₉ chain alkyl ester which give homopolymers having a glass transition temperature of −40° C. or lower include 2-ethylhexyl acrylate (Tg: −70° C.), n-hexyl acrylate (Tg: −65° C.), n-octyl acrylate (Tg: −65° C.), isononyl acrylate (Tg: −60° C.), n-nonyl acrylate (Tg: −58° C.), isooctyl acrylate (Tg: −58° C.) and butyl acrylate (Tg: −55° C.). Of these, butyl acrylate and 2-ethylhexyl acrylate are preferable, with 2-ethylhexyl acrylate being particularly preferable because of low Tg.

The amount of (meth)acrylic acid C₁₀₋₂₀ chain alkyl ester based on 100 parts by weight of the total monomer components of the acryl-based base polymer is preferably 30 to 70 parts by weight, more preferably 33 to 65 parts by weight, further preferably 35 to 60 parts by weight, especially preferable 38 to 55 parts by weight. In particular, the amount of lauryl acrylate is preferably within the above-described range. The amount of acrylic acid C₁₋₉ chain alkyl ester based on 100 parts by weight of the total monomer components of the acryl-based base polymer is preferably 15 to 60 parts by weight, more preferably 20 to 65 parts by weight, further preferably 22 to 65 parts by weight, especially preferable 25 to 55 parts by weight. In particular, the amount of 2-ethylhexyl acrylate is preferably within the above-described range.

It is preferable the acryl-based base polymer contains polar monomers such as a hydroxy group-containing monomer, a carboxy group-containing monomer and a nitrogen-containing monomer, in addition to the above-mentioned (meth)acrylic acid alkyl esters, as monomer components. When the polymer includes polar monomer component, cohesive force of the polymer tends to be enhanced, leading to improvement of adhesion retainability at a high temperature. In addition the hydroxy group or the carboxy group serves as an introduction point for the crosslinked structure when a crosslinked structure is introduced into the acryl-based base polymer with an isocyanate-based crosslinker, an epoxy-based crosslinker or the like.

Examples of the hydroxy group-containing monomer include (meth)acrylic acid esters such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate and 12-hydroxylauryl (meth)acrylate. Among them, 2-hydroxyethyl acrylate (Tg: −15° C.) and 4-hydroxybutyl acrylate (Tg: −32° C.) are preferable because they considerably contribute to enhancement of adhesive strength, and can suppress cloudiness of the pressure sensitive adhesive sheet in a high-humidity environment, and 4-hydroxybutyl acrylate is especially preferable because of its low Tg.

Examples of the carboxy group-containing monomer include acryl-based monomers such as (meth)acrylic acid, carboxyethyl (meth)acrylate and carboxypentyl (meth)acrylate, and unsaturated fatty acids such as itaconic acid, maleic acid, fumaric acid and crotonic acid.

Examples of the nitrogen-containing monomer include vinyl-based monomer such as N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, (meth)acryloylmorpholine, N-vinylcarboxylic acid amides and N-vinylcaprolactam; and cyano acrylate-based monomer such as acrylonitrile and methacrylonitrile. Among them, N-vinylpyrrolidone is preferable because it considerably contribute to enhancement of adhesive strength by improvement of cohesive force.

From the viewpoint of increasing the adhesive strength of the pressure sensitive adhesive sheet, the amount of the polar group-containing monomer based on 100 parts by weight of the total of the monomer components of the acryl-based base polymer is preferably 5 parts by weight or more, more preferably 8 parts by weight or more, further preferably 10 parts by weight or more. On the other hand, when the content of the polar monomer is excessively high, G′ of the pressure sensitive adhesive sheet tends to increase, leading to deterioration of the strain relaxation property. Further, when the content of the polar monomer is excessively high, the glass transition temperature of the polymer tends to increase, leading to deterioration of adhesiveness at a low temperature. Thus, the amount of the polar group-containing monomer based on 100 parts by weight of the total of the monomer components of the acryl-based base polymer is preferably 25 parts by weight or less, more preferably 20 parts by weight or less, further preferably 17 parts by weight or less, especially preferably 15 parts by weight or less.

Preferably, the acryl-based base polymer contains a hydroxy group-containing monomer and a nitrogen-containing monomer among the polar group-containing monomers. Presence of a hydroxy group-containing monomer as the polar monomer component tends to improve the adhesive strength of the pressure sensitive adhesive sheet and suppress cloudiness of the pressure sensitive adhesive sheet in a high-humidity environment. Presence of a nitrogen-containing monomer as the polar monomer component tends to improve the adhesion retaining force of the pressure sensitive adhesive sheet.

The amount of the hydroxy group-containing monomer is preferably 2 to 15 parts by weight, more preferably 3 to 12 parts by weight, further preferably 4 to 10 parts by weight based on 100 parts by weight of the total amount of monomer components of the acryl-based base polymer. In particular, it is preferable that the total amount of 2-hydroxyethyl acrylate and 4-hydroxybutyl acrylate is within the above-described range, and it is more preferable that the amount of 4-hydroxybutyl acrylate is within the above-described range.

The amount of the nitrogen-containing monomer is preferably 2 to 20 parts by weight, more preferably 3 to 15 parts by weight, further preferably 4 to 12 parts by weight based on 100 parts by weight of the total amount of monomer components of the acryl-based base polymer. In particular, it is preferable that the amount of N-vinylpyrrolidone is within the above-described range.

When the pressure sensitive adhesive sheet is used for bonding a touch panel sensor, it is preferable that a pressure sensitive adhesive sheet has a low acid content for preventing corrosion of the electrode by acid components. In addition, when the pressure sensitive adhesive sheet is used for bonding a polarizing plate, it is preferable that a pressure sensitive adhesive sheet has a low acid content for suppressing generation of polyene structure in a polarizer. The content of organic acid monomers, e.g., (meth)acrylic acid, in such an acid-free pressure sensitive adhesive sheet is preferably 100 ppm or less, more preferably 70 ppm or less, further preferably 50 ppm or less. The organic acid monomer content of the pressure sensitive adhesive sheet can be determined by immersing the pressure sensitive adhesive sheet in pure water, heating the pressure sensitive adhesive sheet at 100° C. for 45 minutes, and determining the amount of acid monomers extracted in water by ion chromatography.

For reducing the content of acid monomers in the pressure sensitive adhesive sheet, the amount of organic acid monomer components such as (meth)acrylic acid in the monomer components that form the base polymer is preferably small. Thus, for ensuring that the pressure sensitive adhesive sheet is free from acid, it is preferable that the base polymer does not substantially contain an organic acid monomer (carboxy group-containing monomer) as a monomer component. In the acid-free pressure sensitive adhesive sheet, the amount of the carboxy group-containing monomer is preferably 0.5 parts by weight or less, more preferably 0.1 parts by weight or less, further preferably 0.05 parts by weight or less, ideally 0 parts by weight based on 100 parts by weight of the total monomer components in the base polymer.

The acryl-based base polymer may include monomer component other than the above-mentioned (meth) acrylic acid alkyl esters and polar monomers. Examples of monomer component other than the above-mentioned ones include vinyl-based monomers such as caprolactone adducts of acrylic acids, sulfonic acid group-containing monomers, phosphoric acid group-containing monomers, styrene and α-methylstyrene; cyano group-containing acryl-based monomers such as acrylonitrile and methacrylonitrile; epoxy group-containing monomers such as glycidyl (meth)acrylate; glycol-based acryl ester monomers such as polyethylene glycol (meth)acrylate, polypropylene glycol (meth)acrylate, methoxyethylene glycol (meth)acrylate and methoxypolypropylene glycol (meth)acrylate; and acrylic acid ester-based monomers such as tetrahydrofurfuryl (meth)acrylate, fluorine (meth)acrylate, silicone (meth)acrylate and 2-methoxyethyl (meth)acrylate.

The theoretical Tg of the acryl-based base polymer is preferably −60° C. to −15° C. The theoretical Tg of the acryl-based base polymer is more preferably −20° C. or lower, further preferably −23° C. or lower, specifically preferably −25° C. or lower. The theoretical Tg of the acryl-based base polymer may be −50° C. or higher, −45° C. or higher, −40° C. or higher or −38° C. or higher. The theoretical Tg is calculated from the glass transition temperature Tgᵢ of a homopolymer of a constituent monomer component of the acryl-based base polymer and the weight fraction Wᵢ of each monomer component in accordance with the following Fox equation:

1/Tg=Σ(Wᵢ/Tgᵢ).

Tg represents a glass transition temperature (unit: K) of the polymer chain, Wᵢ represents a weight fraction (copolymerization degree on a weight basis) of a monomer component i forming the segment, and Tgᵢ represents a glass transition temperature (unit: K) of a homopolymer of the monomer component i. As the glass transition temperature of the homopolymer, the value described in Polymer Handbook, 3rd edition (John Wiley & Sons, Inc., 1989) can be referred. As the Tg of a homopolymer of a monomer which is not described in the document, a tan δ peak-top temperature obtained by dynamic viscoelasticity measurement may be employed.

<Crosslinked Structure of Base Polymer>

The acryl-based base polymer which is a main component of the pressure sensitive adhesive sheet has a crosslinked structure. Introduction of a crosslinked structure into the base polymer tends to increase the gel fraction of the pressure sensitive adhesive, and reduce the viscous behavior, leading to an increase in tan δ. In addition, introduction of a crosslinked structure tends to increase G′₁₀₀ and improve the adhesion retaining force at a high temperature. On the other hand, excessive introduction of a crosslinked structure tends to reduce viscosity, resulting in deterioration of adhesiveness particularly at a low temperature. In addition, when the amount of a crosslinked structure introduced increases, tan δ₁₀₀ tends to decrease, leading to an increase in difference between tan δ₂₅ and tan δ₁₀₀.

For the pressure sensitive adhesive sheet to have appropriate viscoelasticity, the gel fraction of the pressure sensitive adhesive sheet is preferably 55 to 85%, more preferably 60 to 80%, further preferably 63 to 77%, especially preferably 65 to 75%. By adjusting the gel fraction within this range, a high adhesion retaining force can be exhibited even when G′ is small and the pressure sensitive adhesive sheet is soft.

The gel fraction can be determined as a content of components insoluble in a solvent such as ethyl acetate, and specifically, the gel fraction is determined as a weight fraction (unit: % by weight) of insoluble components after immersion of the pressure sensitive adhesive layer in ethyl acetate at 23° C. for 7 days to the sample before immersion. Generally, the gel fraction of the polymer is equal to a crosslinking degree, and the gel fraction becomes higher as the number of crosslinked moieties in the polymer increases. The gel fraction (introduction amount of crosslinked structure) can be adjusted within a desired range by a method for introducing a crosslinked structure, the type and the amount of a crosslinker, and the like.

Examples of the method for introducing a crosslinked structure into a base polymer include (1) a method in which a base polymer having a functional group capable of reacting with a crosslinker is prepared, and the crosslinker is then added to react the base polymer with the crosslinker; and (2) a method in which a polyfunctional compound is incorporated in polymerization components of a base polymer to introduce a branched structure (crosslinked structure) into the polymer chain. With these approaches used in combination, a plurality of crosslinked structures may be introduced into the base polymer.

In the above-mentioned method (1) in which a base polymer and a crosslinker are reacted, the crosslinker is added to the base polymer after polymerization, and the mixture is optionally heated to introduce a crosslinked structure into the base polymer. Examples of the crosslinker include compounds that react with functional groups such as a hydroxy group and a carboxy group contained in the base polymer. Specific examples of the crosslinker include isocyanate-based crosslinkers, epoxy-based crosslinkers, oxazoline-based crosslinkers, aziridine-based crosslinkers, carbodiimide-based crosslinkers and metal chelate-based crosslinkers.

In particular, isocyanate-based crosslinkers and epoxy-based crosslinkers are preferable because they have high reactivity with the hydroxy group and the carboxy group of the base polymer, so that introduction of a crosslinked structure is facilitated. Such a crosslinker forms a crosslinked structure by reacting with functional groups such as a hydroxy group and a carboxy group which are introduced into the base polymer. In an acid-free pressure sensitive adhesive in which the base polymer does not contain a carboxy group, it is preferable to form a crosslinked structure by use of an isocyanate-based crosslinker, i.e., by reaction of a hydroxy group in the base polymer with the isocyanate crosslinker.

As an isocyanate-based crosslinker, a polyisocyanate having two or more isocyanate groups per molecule is used. Examples of the isocyanate-based crosslinker include lower aliphatic polyisocyanates such as butylene diisocyanate and hexamethylene diisocyanate; cycloaliphatic isocyanates such as cyclopentylene diisocyanate, cyclohexylene diisocyanate and isophorone diisocyanate; aromatic isocyanates such as 2,4-tolylene diisocyanate, 4,4′-diphenylmethane diisocyanate and xylylene diisocyanate; isocyanate adducts such as trimethylolpropane/tolylene diisocyanate trimer adducts (e.g. “CORONATE L” manufactured by Tosoh Corporation), trimethylolpropane/hexamethylene diisocyanate trimer adducts (e.g. “CORONATE HL” manufactured by Tosoh Corporation), trimethylolpropane adducts of xylylene diisocyanate (e.g. “TAKENATE D110N” manufactured by Mitsui Chemicals, Incorporated) and isocyanurate forms of hexamethylene diisocyanate (e.g. “CORONATE HX” manufactured by Tosoh Corporation).

In the method of adding a polyfunctional monomer to the polymerization component for the base polymer in (2) above, the total amount of a monomer component for forming the acryl-based base polymer and the polyfunctional compound for introducing a crosslinked structure may be reacted at once, or polymerization may be performed in a multiple stages. As a method for performing polymerization in multiple stages, a method is preferable in which a monofunctional monomer for forming a base polymer is polymerized (prepolymerized) to prepare a partially polymerized product (prepolymer composition), and a polyfunctional compound such as a polyfunctional (meth)acrylate is added to the prepolymer composition to polymerize the prepolymer composition and the polyfunctional monomer (main polymerization). The prepolymer composition is a partially polymerized product containing a polymerized product with a low polymerization degree and an unreacted monomer.

By performing prepolymerization of a constituent component of the acryl-based base polymer, branch points (crosslinking points) with a polyfunctional compound can be uniformly introduced into the base polymer. In addition, the pressure sensitive adhesive sheet can also be formed by applying a mixture of a low-molecular-weight polymer or a partially polymerized product and an unpolymerized monomer component (pressure sensitive adhesive composition) onto a substrate, and then performing main polymerization on the substrate. A low polymerization ratio composition such as a prepolymer composition has a low viscosity, and is thus excellent in application property, and therefore by using a method in which a pressure sensitive adhesive composition that is a mixture of a prepolymer composition and a polyfunctional compound is applied, and then main polymerization is performed on a substrate, productivity of the pressure sensitive adhesive sheet can be improved, and the thickness of the pressure sensitive adhesive sheet can be made uniform.

Examples of the polyfunctional compound to be used for introducing a crosslinked structure include compounds having two or more polymerizable functional groups having an unsaturated double bond (ethylenically unsaturated group) in one molecule. The polyfunctional compound is preferably a polyfunctional (meth)acrylate because it is easily copolymerized with the monomer component of the acryl-based base polymer. When a branched (crosslinked) structure is introduced by active energy ray polymerization (photopolymerization), a polyfunctional acrylate is preferable.

Examples of the polyfunctional (meth)acrylate include polyethylene glycol di(meth)acrylate, polypropylene glycol di(meth)acrylate, polytetramethylene glycol di(meth)acrylate, bisphenol A ethylene oxide-modified di(meth)acrylate, bisphenol A propylene oxide-modified (meth)acrylate, alkanediol di(meth)acrylate, tricyclodecane dimethanol di(meth)acrylate, ethoxylated isocyanuric acid tri(meth)acrylate, pentaerythritol tri(meth)acrylate, pentaerythritol di(meth)acrylate, trimethylolpropane tri(meth)acrylate, ditrimethylolpropane tetra(meth)acrylate, ethoxylated pentaerythritol tetra(meth)acrylate, pentaerythritol tetra(meth)acrylate, dipentaerythritol poly(meth)acrylate, dipentaerythritol hexa(meth)acrylate, neopentyl glycol di(meth)acrylate, glycerin di(meth)acrylate, epoxy (meth)acrylate, butadiene (meth)acrylate and isoprene (meth)acrylate.

From the viewpoint of appropriately adjusting the viscoelasticity such as G′ and tan δ by introducing a crosslinked structure, the molecular weight of the polyfunctional compound such as polyfunctional (meth) acrylate is preferably 1500 or less, more preferably 1000 or less. The functional group equivalent (g/eq) of the polyfunctional compound is preferably 50 to 500, more preferably 70 to 300, further preferably 80 to 200.

<Preparation of Base Polymer>

The acryl-based base polymer can be prepared by e.g., solution polymerization, UV polymerization, mass polymerization or emulsification polymerization. Solution polymerization methods or UV polymerization is preferable from the viewpoint of transparency, water resistance, costs and so on of the pressure sensitive adhesive. As a solvent for solution polymerization, ethyl acetate, toluene or the like is generally used.

In preparation of the acryl-based base polymer, a polymerization initiator such as a photopolymerization initiator or a thermopolymerization initiator may be used depending on a type of polymerization reaction. The photopolymerization initiator is not particularly limited as long as it initiates photopolymerization, and examples of the photopolymerization initiator include: a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, a thioxanthone-based photopolymerization initiator, an acyl phosphine oxide-based photopolymerization initiator. Examples of the thermopolymerization initiator include: an azo-based initiator, a peroxide-based initiator, a redox-based initiator obtained by combining a peroxide and a reducing agent (e.g., combination of a persulfate and sodium hydrogen sulfite, combination of a peroxide and sodium ascorbate.

In polymerization, a chain-transfer agent, a polymerization inhibitor (polymerization-delaying agent) or the like may be used for the purpose of, for example, adjusting the molecular weight. Examples of the chain-transfer agent include thiols such as α-thioglycerol, lauryl mercaptan, glycidyl mercaptan, mercaptoacetic acid, 2-mercaptoethanol, thioglycolic acid, 2-ethylhexyl thioglycolate and 2,3-dimercapto-1-propanol, and α-methylstyrene dimers.

By adjusting the type and amount of the polymerization initiator, the molecular weight of the base polymer can be adjusted. For example, in radical polymerization, when the amount of the polymerization initiator increases, the concentration of radicals in the reaction system becomes higher, so that the density of reaction starting points tends to increase, leading to a decrease in molecular weight. Conversely, when the amount of the polymerization initiator decreases, the density of reaction starting points becomes lower, so that the polymer chain tends to easily extend, leading to an increase in molecular weight.

For obtaining a pressure sensitive adhesive sheet having small G′ and excellent adhesive strength, it is preferable that the acryl-based base polymer has a high gel fraction with a small density of crosslinking points. In order to increase the gel fraction (ratio of polymer chains in which a crosslinked structure is introduced) with a small crosslinking density, the molecular weight of the base polymer (polymer chain length) may be increased. For increasing the molecular weight of the base polymer as described above, it is preferable to reduce the amount of the polymerization initiator used in formation of the base polymer by polymerization.

The amount of the polymerization initiator used during formation of the base polymer by polymerization may be appropriately set according to the type of polymerization reaction, the composition of monomers, the type of polymerization initiator, the target molecular weight, and the like. From the viewpoint of increasing the molecular weight of the base polymer to increase the gel fraction with a small amount of crosslinker, the amount of the polymerization initiator is preferably 0.001 to 0.4 parts by weight, more preferably 0.003 to 0.1 parts by weight, further preferably 0.005 to 0.05 parts by weight, based on 100 parts by weight of the total monomer components that form the base polymer.

When a crosslinked structure is introduced with an isocyanate-based crosslinker or the like, it is preferable that after formation of the base polymer by solution polymerization, a crosslinker is added, and the mixture is heated if necessary to introduce the crosslinked structure into the base polymer. When a crosslinked structure is introduced with a polyfunctional compound such as a polyfunctional (meth)acrylate, it is preferable that solution polymerization or active energy ray polymerization is performed to form the base polymer or prepare a prepolymer composition, the polyfunctional compound is added, and the crosslinked structure is then introduced with the polyfunctional compound by active energy ray polymerization.

The prepolymer composition can be prepared by, for example, partially polymerizing (preliminarily polymerizing) a composition obtained by mixing a polymerization initiator with a monomer component that forms the acrylic base polymer (referred to as a “prepolymer-forming composition”). The monomer in the prepolymer-forming composition is preferably a monofunctional monomer component such as a (meth)acrylic acid alkyl ester or a polar group-containing monomer. The prepolymer-forming composition may contain a polyfunctional monomer in addition to the monofunctional monomer. For example, a part of the polyfunctional monomer component may be added to the prepolymer-forming composition, followed by performing prepolymerization, then adding the remaining part of the polyfunctional monomer component, and performing main polymerization.

Although the polymerization degree of the prepolymer is not particularly limited, the polymerization degree is preferably 3 to 50% by weight, more preferably 5 to 40% by weight from the viewpoint of obtaining a viscosity suitable for application of the prepolymer onto a substrate. The polymerization degree of the prepolymer can be adjusted to fall within a desired range by adjusting the type and amount of the photopolymerization initiator, the irradiation intensity and irradiation time of an active ray such as UV light, and so on.

<Acryl-Based Oligomer>

The pressure sensitive adhesive sheet may contain an oligomer in addition to the acryl-based base polymer. As the acryl-based oligomer, one having a weight average molecular weight of about 1000 to 30000 is used. The acryl-based oligomer contains a (meth)acrylic acid alkyl ester as a main constituent monomer component.

The glass transition temperature of the acryl-based oligomer is preferably 60° C. or higher, more preferably 80° C. or higher, further preferably 100° C. or higher, especially preferably 110° C. or higher for improving adhesive strength of the pressure sensitive adhesive sheet. When a low Tg acryl-based base polymer having crosslinked structure, and a high Tg acryl-based oligomer are used in combination, the adhesive strength of the pressure sensitive adhesive sheet tends to be improved, and in particular the adhesion retaining force at a high temperature tends to be improved. The upper limit of the glass transition temperature of the acryl-based oligomer is not particularly limited. The glass transition temperature is generally 200° C. or lower, preferably 180° C. or lower, more preferably 160° C. or lower. The glass transition temperature of the acryl-based oligomer is calculated in accordance with the Fox equation.

The acryl-based oligomer having a glass transition temperature of 60° C. or more is preferably one containing as a constituent monomer component a (meth)acrylic acid alkyl ester having a chain alkyl group (chain alkyl (meth)acrylate) and a (meth)acrylic acid alkyl ester having a cycloaliphatic alkyl group (cycloaliphatic alkyl (meth)acrylate). Specific examples of the linear alkyl (meth)acrylate and the cycloaliphatic alkyl (meth)acrylate are as shown above as constituent monomers of the acryl-based base polymer.

Among the shown (meth)acrylic acid alkyl esters, the chain alkyl (meth)acrylate is preferably methyl methacrylate because it has a high glass transition temperature, and is excellent in compatibility with the base polymer. As the cycloaliphatic alkyl (meth)acrylate, dicyclopentanyl acrylate, dicyclopentanyl methacrylate, cyclohexyl acrylate and cyclohexyl methacrylate are preferable. That is, the acryl-based oligomer is preferably one containing as constituent monomer components at least one selected from the group consisting of dicyclopentanyl acrylate, dicyclopentanyl methacrylate, cyclohexyl acrylate and cyclohexyl methacrylate, and methyl methacrylate.

The amount of the cycloaliphatic alkyl (meth)acrylate based on the total amount of monomer components for forming the acryl-based oligomer is preferably 10 to 90% by weight, more preferably 20 to 80% by weight, further preferably 30 to 70% by weight. The amount of the chain alkyl (meth)acrylate based on the total amount of monomer components for forming the acryl-based oligomer is preferably 10 to 90% by weight, more preferably 20 to 80% by weight, further preferably 30 to 70% by weight.

The weight average molecular weight of the acryl-based oligomer is preferably 1000 to 30000, more preferably 1500 to 10000, further preferably 2000 to 8000. When an acryl-based oligomer having a molecular weight falling within the above-mentioned range is used, the adhesive strength and the adhesion retaining force of the pressure sensitive adhesive tend to be improved.

The acryl-based oligomer is obtained by polymerizing the above-mentioned monomer components by various polymerization methods. In polymerization of the acryl-based oligomer, various polymerization initiators may be used. In addition, a chain-transfer agent may be used for the purpose of adjusting the molecular weight.

The content of the acryl-based oligomer in the pressure sensitive adhesive sheet is not particularly limited. For sufficiently enhancing adhesive strength, the amount of the acryl-based oligomer based on 100 parts by weight of the base polymer is preferably 0.5 parts by weight or more, more preferably 0.8 parts by weight or more, further preferably 1 part by weight or more. The amount of acryl-based oligomer in the pressure sensitive adhesive sheet may be 1.3 parts by weight or more, 1.5 parts by weight or more, 1.8 parts by weight or more, 2 parts by weight or more, 2.3 parts by weight or 2.5 parts by weight or more, based on 100 parts by weight of the base polymer. Adhesive strength tends to be improved as the amount of a high-Tg acryl-based oligomer increases.

On the other hand, when the amount of the acryl-based oligomer is excessively large, the haze of the pressure sensitive adhesive sheet tends to increase due to reduction of compatibility, leading to deterioration of transparency. Since the pressure sensitive adhesive sheet arranged on the viewing-side from the image display panel is required to have high transparency, the amount of the acryl-based oligomer in the pressure sensitive adhesive sheet is preferably 10 parts by weight or less, more preferably 7 parts by weight or less, further preferably 6 parts by weight or less, especially preferably 5 parts by weight or less, based on 100 parts by weight of the base polymer.

<Pressure Sensitive Adhesive Composition>

Acryl-based base polymer (or prepolymer composition), the acryl-based oligomer, the crosslinker for introducing a crosslinked structure and/or the polyfunctional compound, other additives, and the like are mixed to prepare a pressure sensitive adhesive composition. The remaining part of the monomer component that forms the acryl-based base polymer may be added to the pressure sensitive adhesive composition if necessary. A viscosity-enhancing additive or the like may be used for the purpose of for example, adjusting the viscosity.

When the pressure sensitive adhesive composition contains the prepolymer composition and the polyfunctional compound, it is preferable that the pressure sensitive adhesive composition contains a photopolymerization initiator for main polymerization. After the prepolymerization, a polymerization initiator for main polymerization may be added to the prepolymer composition. When the polymerization initiator in prepolymerization remains in the prepolymer composition without being deactivated, the addition of the polymerization initiator for main polymerization may be omitted. The pressure sensitive adhesive composition may contain a chain-transfer agent.

In the pressure sensitive adhesive composition, the content of the acryl-based base polymer (or prepolymer composition) based on the total amount of nonvolatile contents is preferably 50% by weight or more, more preferably 70% by weight, further preferably 80% by weight or more, especially preferably 90% by weight or more.

The amount of the crosslinker and/or the polyfunctional compound in the pressure sensitive adhesive composition may be adjusted so that the gel fraction falls within the above-described range. For obtaining a pressure sensitive adhesive sheet having small G′ and excellent adhesive strength, it is preferable that the molecular weight of the acryl-based base polymer is increased to achieve a high gel fraction with a small density of crosslinking points. For example, when a crosslinked structure is introduced with an isocyanate-based crosslinker, the amount of the crosslinker is preferably 0.005 to 0.5 parts by weight, more preferably 0.01 to 0.3 parts by weight, further preferably 0.02 to 0.1 parts by weight, based on 100 parts by weight of the acryl-based base polymer. When a crosslinked structure is introduced with a polyfunctional (meth)acrylate, the amount of the polyfunctional (meth)acrylate is preferably 0.005 to 0.3 parts by weight, more preferably 0.01 to 0.2 parts by weight, further preferably 0.02 to 0.1 parts by weight, based on 100 parts by weight of the acryl-based base polymer (prepolymer).

(Silane Coupling Agent)

A silane coupling agent can also be added in the pressure sensitive adhesive composition for the purpose of adjusting the adhesive strength. When the pressure sensitive adhesive composition includes a silane coupling agent, the content thereof is normally about 0.01 to 5.0 parts by weight, preferably 0.03 to 2.0 parts by weight based on 100 parts by weight of the base polymer.

(Other Additives)

In addition to the components exemplified above, additives such as a tackifier, a plasticizer, a softener, a degradation inhibitor, a filler, a colorant, an ultraviolet absorber, an antioxidant, a surfactant and an antistatic agent maybe contained in the pressure sensitive adhesive composition.

<Formation of Pressure Sensitive Adhesive Sheet>

A pressure sensitive adhesive sheet is formed on a substrate by applying the pressure sensitive adhesive composition onto the substrate, and optionally performing drying of solvent and/or main polymerization by irradiating an active ray. For the substrate to be used for formation of the pressure sensitive adhesive sheet, any suitable material is used. The substrate may be a release film having a release layer on a contact surface with the pressure sensitive adhesive sheet.

As the base film of the release film, films composed of various resin materials are used. Examples of the resin material include polyester-based resins such as polyethylene terephthalate and polyethylene naphthalate, acetate-based resins, polyether sulfone-based resins, polycarbonate-based resins, polyamide-based resins, polyimide-based resins, polyolefin-based resins, (meth)acryl-based resins, polyvinyl chloride-based resins, polyvinylidene chloride-based resins, polystyrene-based resins, polyvinyl alcohol-based resins, polyacrylate-based resins and polyphenylene sulfide-based resins. Among them, polyester-based resins such as polyethylene terephthalate are especially preferable. The thickness of the base film is preferably 10 to 200 μm, more preferably 25 to 150 μm. Examples of the material of the release layer include silicone-based release agents, fluorine-based release agents, long-chain alkyl-based release agents and aliphatic amide-based release agents. The thickness of the release layer is generally about 10 to 2000 nm.

For applying the pressure sensitive adhesive composition on the substrate, various kinds of coating methods such as roll coating, kiss roll coating, gravure coating, reverse coating, roll brushing, spray coating, dip roll coating, bar coating, knife coating, air knife coating, curtain coating, lip coating, and extrusion coating may be employed.

When the base polymer of the pressure sensitive adhesive composition is a solution-polymerized polymer, it is preferable to perform drying the solvent after applying the pressure sensitive adhesive composition on the substrate. As a method for drying, a suitable method can be appropriately employed according to a purpose. The heating/drying temperature is preferably 40° C. to 200° C., more preferably 50° C. to 180° C., further preferably 70° C. to 170° C. Drying time can be appropriately set. The drying time is preferably 5 seconds to 20 minutes, more preferably 5 seconds to 15 minutes, further preferably 10 seconds to 10 minutes.

When the pressure sensitive adhesive composition contains a crosslinker, crosslinking reaction may be carried out after the pressure sensitive adhesive composition is applied onto the substrate. At the time of crosslinking, heating may be performed if necessary. The temperature of the crosslinking reaction is normally in the range of 20° C. to 160° C., and the time of the crosslinking reaction is about 1 minute to 7 days. The heating for removing the solvent by drying after application of the pressure sensitive adhesive composition may also serve as heating for crosslinking. After the solvent is dried, it is preferable to dispose a cover sheet for protecting the surface of the pressure sensitive adhesive sheet. Preferably, a release film having a release layer on the contact surface with the pressure sensitive adhesive sheet, like the base film, is used as the cover sheet.

When the pressure sensitive adhesive composition is a photopolymerizable composition containing a prepolymer composition, a polyfunctional compound and the like, the pressure sensitive adhesive composition is applied onto the substrate in the form of a layer, and then irradiated with an active ray to be photocured. During photocuring, it is preferable to attach a cover sheet to the surface of the applied layer and irradiate the pressure sensitive adhesive composition with active ray in a state where the pressure sensitive adhesive composition is sandwiched between two sheets, to prevent the inhibition of polymerization due to oxygen.

The active ray may be selected according to the type of a polymerizable component such as a monomer or a polyfunctional (meth)acrylate, the type of a photopolymerization initiator or the like, and in general, an ultraviolet ray and/or visible light having a short wavelength are used. The accumulated amount of irradiation light is preferably about 100 to 5000 mJ/cm². The light source for photoirradiation is not particularly limited as long as it can emit light in a wavelength range over which the photopolymerization initiator contained in the pressure sensitive adhesive composition is sensitive to light, and an LED light source, a high-pressure mercury lamp, an ultra-high mercury lamp, a metal halide lamp, a xenon lamp, and the like are preferably used.

[Stacking Configuration and Shape of Pressure Sensitive Adhesive Sheet]

Release films 91 and 92 are bonded, respectively, to surfaces of the pressure sensitive adhesive sheet 11 to obtain a pressure sensitive adhesive sheet in which a release film is temporarily attached to each of both surfaces as shown in FIG. 1. The substrate and the cover sheet used for formation of the pressure sensitive adhesive sheet may be remain attached to the pressure sensitive adhesive to be used as release films 91 and 92.

When release films 91 and 92 are disposed on both surfaces of the pressure sensitive adhesive sheet 11, the thickness of one release film 91 and the thickness of the other release film 92 may be the same, or different. The peeling strength in peeling of the release film temporarily attached to one surface from the pressure sensitive adhesive sheet 11 and the peeling strength in peeling of the release film temporarily attached to the other surface from the pressure sensitive adhesive sheet 11 may be the same or different. When the peeling strength of the release film on one surface is different from the peeling strength of the release film on the other surface, excellent workability can be attained by performing the bonding of adherends in the following procedure: the release film 91 with relatively small peeling strength (light-release film) is first peeled from the pressure sensitive adhesive sheet 11, and bonded to a first adherend, and the release film 92 with relatively large peeling strength (heavy-release film) is peeled, and bonded to a second adherend.

In formation of the pressure sensitive adhesive sheet, a pressure sensitive adhesive sheet having a large area (mother substrate) is produced by the roll-to-roll method, and then cut into a predetermined size according to the size of the adherend, to obtain a sized piece of pressure sensitive adhesive. In this method, a large number of sized pieces of pressure sensitive adhesive are obtained from the mother substrate, whereby the productivity of the pressure sensitive adhesive sheets can be improved.

The shape and size of the sized piece of the pressure sensitive adhesive are set according to the shape and size of the adherend. For example, when the pressure sensitive adhesive sheet is used for formation of an image display device, the size of the pressure sensitive adhesive sheet is substantially equal to the size of the screen. The area of the sized piece of the pressure sensitive adhesive is generally from about 5 to 25000 cm². The area of the sized piece of the pressure sensitive adhesive may be 10000 cm² or less, 5000 cm² or less, 3000 cm² or less, 1000 cm² or less, or 500 cm² or less. When the pressure sensitive adhesive sheet is rectangular, the length of the diagonal line is from about 3 to 250 cm. The length of the diagonal line of the pressure sensitive adhesive sheet may be 100 cm or less, 50 cm or less, 30 cm or less, or 20 cm or less. When the pressure sensitive adhesive sheet is rectangular, the shape of the pressure sensitive adhesive sheet may be a rectangle having a long side and a short side, or a square having four sides having an equal length. The length of the long side of the rectangle is generally 10 times or less that of the short side, and may be 5 times or less, 3 times or less, or 2 times or less.

In the sized piece of pressure sensitive adhesive sheet, as shown in FIG. 3, the end surface of the pressure sensitive adhesive sheet 11 may be positioned inside with respect to the end surfaces of the release films 91 and 92, and the release films 91 and 92 may be disposed so as to protrude outside the outer peripheral edge of the pressure sensitive adhesive sheet 11. As shown in FIG. 4, the end surface of the pressure sensitive adhesive sheet may be positioned inside with respect to the end surface of the release film near the central part of the pressure sensitive adhesive sheet in the thickness direction while the end surface of the pressure sensitive adhesive sheet substantially coincides with the end surface of the release film near the interface between the pressure sensitive adhesive sheet 11 and the release films 91 and 92.

When the pressure sensitive adhesive has a low storage elastic modulus G′ and high fluidity, the pressure sensitive adhesive easily protrudes from the end surface of the sized piece of the pressure sensitive adhesive sheet, so that glue missing and glue contamination easily occur. Since the end surface of the pressure sensitive adhesive sheet 11 is positioned inside with respect to the end surfaces of the release films 91 and 92 as shown in FIGS. 3 and 4, glue contamination and glue missing due to protrusion of the pressure sensitive adhesive from the end surface can be prevented.

Existence or non-existence and the shape of a portion in which the lateral surface (end surface) of the pressure sensitive adhesive sheet 11 is positioned inside with respect to the release films 91 and 92 are not limited to the above, and can be appropriately set. In a pressure sensitive adhesive layer-equipped optical film and a laminate as described later, glue contamination, glue missing and the like due to protrusion of the pressure sensitive adhesive from the end surface can be suppressed as long as the end surface of the pressure sensitive adhesive sheet is positioned inside with respect to the end surfaces of an adherend such as an optical film and/or the release film.

A sized piece of pressure sensitive adhesive sheet in which the release films 91 and 92 protrude outside the outer peripheral edge of the pressure sensitive adhesive sheet 11 as shown in FIG. 3 can be obtained by, for example, a method in which a laminate with a release film provided on both surfaces of a pressure sensitive adhesive sheet is subjected to half-cutting from one surface to cut the release film and the pressure sensitive adhesive sheet on the surface, the release film on the cut surface side and the pressure sensitive adhesive sheet in a region surrounded by the cut line are then peeled off, another release film is bonded, and the laminate is cut to a sized piece.

The protrusion amount of the release film on one surface may be same as or different from the protrusion amount of the release film on the other surface. It is easy to selectively pinch the release film to be peeled off when the protrusion amounts of the release films 91 and 92 are different from each other as shown in FIG. 3. In particular, when the protrusion amount of the light-release film 91 is larger, it is easy to selectively pinch and peel off the light-release film 91 from the laminate in which the light-release film 91 and the heavy-release film 92 are temporarily adhered to the pressure sensitive adhesive sheet 11. Therefore, it is advantageous for peeling off the release film from the pressure sensitive adhesive sheet and automating the bonding work on the adherend.

Examples of the method for preparing a sized piece of pressure sensitive adhesive sheet in which the end surface of the pressure sensitive adhesive sheet is positioned inside with respect to the end surface of the release film near the central part of the pressure sensitive adhesive sheet in the thickness direction as shown in FIG. 4 include the following method: pressure is applied to the pressure sensitive adhesive sheet from above the release films 91 and 92 to protrude the pressure sensitive adhesive from the end surface, and in this state, the pressure sensitive adhesive sheet 11 is cut together with the release films 91 and 92. When the pressure is released after cutting, the end surface of the pressure sensitive adhesive sheet moves back to inside the end surfaces of the release films 91 and 92. When this method is employed, it is preferable that a mother substrate prepared by a roll-to-roll method is punched with a Thomson blade or the like, a plurality of release film-equipped pressure sensitive adhesive sheet after the punching are piled, and pressurized in a pilling direction to protrude the pressure sensitive adhesive from the lateral surface. In this state, the laminate is cut at the inside of a cut surface formed by the punching, so that the laminate is finished to a product size.

[Image Display Device]

The pressure sensitive adhesive sheet of the present invention can be used for bonding various transparent members and opaque members. The type of the adherend is not particularly limited, and examples thereof include various resin materials, glass and metals. The pressure sensitive adhesive sheet of the present invention has small G′, is excellent in strain relaxation, has high adhesiveness, and is unlikely to peel from an adherend even when a bent state is maintained for a long time or bending is repeated. Thus, the pressure sensitive adhesive sheet of the present invention is suitably used for bonding members in a bendable image display device (flexible display).

FIG. 2 is a sectional view of a configuration of a flexible display in which a touch panel 41, a circularly polarizing plate 31 and a cover window 71 are disposed on a viewing-side surface of an OLED panel 51 as an image display panel. In the flexible display, all of these members have flexibility, and are bendable.

The longitudinal elastic modulus (Young's modulus) of each member that forms the flexible display is about 0.1 to 10 GPa, preferably 0.5 to 7 GPa, more preferably 1 to 5 GPa. The thickness of each member that forms the flexible display is about 10 to 3000 μm, preferably 1000 μm or less, more preferably 500 μm or less. When the longitudinal elastic modulus and the thickness of the flexible member are within the above-described ranges, bending is possible, and damage caused by strain when the bending is repeated or when the bending state is maintained tends to be suppressed.

In each member that forms the flexible display, the yield point elongation in a stress-strain curve is preferably 5% or more. A material with a large yield point elongation has a large elastic deformation region, and is therefore excellent in recovery property when the material is returned to a straight state after being held in a bent state for a long time.

<Image Display Panel>

The OLED panel includes a pair of electrodes and an organic light emitting layer on a substrate, the organic light emitting layer being sandwiched between the electrodes. The OLED panel may be either a top emission type panel in which a metal electrode, an organic light emitting layer and a transparent electrode are stacked in this order on a substrate, or a bottom emission type panel in which a transparent electrode, an organic light emitting layer and a metal electrode are stacked in this order on a substrate. In both the bottom emission type and the top emission type, the substrate, the sealing member and the like provided on the viewing-side from the organic light emitting layer are transparent. The substrate, the sealing member and the like provided on the back side (the housing 75-side in FIG. 2) from the organic light emitting layer are not required to be transparent. In the flexible OLED panel of bottom emission type, the substrate is not required to be transparent, and polyimide or the like may be used as a substrate material. The substrate material may be a transparent resin material such as polyetheretherketone or transparent polyimide. Aback sheet may be provided on the back side of the substrate for the purpose of protecting and reinforcing the substrate.

The image display panel is not limited to the OLED panel, and may be a liquid crystal panel or an electrophoretic display panel (electronic paper). A bendable liquid crystal panel can be formed by using, for example, flexible substrates such as resin substrates as transparent substrates between which a liquid crystal layer is sandwiched.

<Touch Panel>

The touch panel 41 may be any type of touch panel such as resistance film type, capacitance type, optical type or ultrasonic type. When the touch panel 41 is disposed at a position away from the cover window 71 as shown in FIG. 2, a touch panel of capacitance type is preferable.

In a flexible display, a flexible substrate is also used for an electrode-forming substrate or the like of a touch panel. The flexible display is not required to include a touch panel. In the configuration in FIG. 2, the touch panel 41 is arranged between the circularly polarizing plate 31 and the OLED panel 51. A touch panel may be arranged on the viewing-side from the circularly polarizing plate 31, or the cover window 71 may be integrated with the touch panel.

<Polarizing Plate>

A polarizing plate 31 is generally arranged on the viewing-side of the image display panel. For example, in the liquid crystal display, the polarizing plate arranged on the viewing-side of the liquid crystal panel adjusts the transmittance according to the polarization state of light transmitted through the liquid crystal cell. In the OLED display device, by arranging the circularly polarizing plate 31 on the viewing-side of the OLED panel 51, emission of external light reflected at the metal electrode of the OLED panel to the viewing-side can be blocked to improve the visuality of the display.

In general, the polarizing plate includes a polarizer and an appropriate transparent protective film is bonded to one or both surfaces of as necessary. The polarizer is not particularly limited, and various polarizers can be used. Examples of the polarizer include films obtained by uniaxially stretching a hydrophilic polymer film such as a polyvinyl alcohol-based film, a partially formulated polyvinyl alcohol-based film or an ethylene-vinyl acetate copolymer-based partially saponified film with a dichroic substance such as iodine or a dichroic dye adsorbed to the film, and polyene-based oriented films such as dehydrated products of polyvinyl alcohol and dehydrochlorinated products of polyvinyl chloride.

As the polarizer, a thin polarizer having a thickness of 10 μm or less can also be used. Examples of the thin polarizer include thin polarizers as described in JP 51-069644 A, JP 2000-338329 A, WO 2010/100917, JP 4691205 B, JP 4751481 B, and so on. These thin polarizers can be prepared by, for example, a method including the steps of stretching a laminate of polyvinyl alcohol-based resin layer and a stretchable resin base film; and performing iodine dying to the polyvinyl alcohol-based resin layer.

For the transparent protective film as a polarizer protecting film, a transparent resin film such as a cellulose-based resin, a cyclic polyolefin-based resin, an acryl-based resin, a phenylmaleimide-based resin or a polycarbonate-based resin is preferably used. When the transparent protective films are disposed on both surfaces of the polarizer, the protective films on one surface and the other surface may be composed of the same polymer material or may be composed of different polymer materials.

An optical film may be laminated on one surface or both surfaces of the polarizing film with an appropriate adhesive layer or pressure sensitive adhesive layer interposed therebetween if necessary. Examples of such films include one used for manufacturing an image display device such as retarders, wide-viewing films, limited-viewing (peep-preventing) films and brightness enhancement films. The type thereof is not particularly limited. For example, in the liquid crystal display, an optical compensation film may be arranged between the image display panel (liquid crystal panel) and the polarizing plate for the purpose of improving a viewing angle property by appropriately converting the polarization state of light emitted from the liquid crystal cell to the viewing-side.

As described above, in the OLED display device, emission of external light reflected at the metal electrode to the viewing-side can be blocked by providing a circularly polarizing plate with a quarter wave plate disposed on a surface of a polarizer on the OLED panel-side. By disposing a quarter-wave plate on the viewing-side of the polarizer to circularly polarize emitted light, an appropriate image can be viewed even by a viewer wearing polarization sunglasses. Such an optical film (optically anisotropic film) may be laminated on the polarizer without interposing other films therebetween. In this case, the optical film also has a function as a protective film for the polarizer.

The thickness of the polarizing plate is generally about 10 to 200 μm. From the viewpoint of providing flexibility, the thickness of the polarizing plate used for the flexible display is preferably 100 μm or less, more preferably 80 μm or less, further preferably 70 μm or less. When an optical film such as a quarter-wave plate is laminated on the polarizing plate, the total thickness including the thickness of the optical film is preferably within the above-described range.

<Cover Window>

The cover window 71 is disposed on the outermost surface of the image display device on the viewing-side for the purpose of, for example, preventing damage to the image display panel due to an impact from the outer surface. In the flexible display, a flexible transparent substrate of transparent polyimide, polyether ether ketone or the like is used as the cover window 71. A flexible glass plate (glass film) may be used as the material of the cover window 71, and the cover window 71 may have a configuration in which a glass film and a resin film are laminated. From the viewpoint of attaining both strength and flexibility, the thickness of the cover window is preferably 20 to 500 μm, more preferably 35 to 300 μm, further preferably 50 to 200 μm. The yield point elongation of the cover window is preferably 5% or more because of the excellent recovery property after maintaining the bent state for a long time. As the cover window 71, a bendable thin glass substrate may be used. An antireflection layer, a hard coat layer or the like may be provided on a viewing-side surface of the cover window.

<Lamination of Members Using Pressure Sensitive Adhesive Sheet>

The pressure sensitive adhesive sheet is used for bonding the flexible members. In the image display device shown in FIG. 2, the OLED panel 51 and the bottom surface of the housing 75 are bonded to each other with a pressure sensitive adhesive sheet 14 interposed therebetween, the OLED panel 51 and the touch panel 41 are bonded to each other with a pressure sensitive adhesive sheet 13 interposed therebetween, the touch panel 41 and the circularly polarizing plate 31 are bonded to each other with a pressure sensitive adhesive sheet 12 interposed therebetween, and the circularly polarizing plate 31 and the cover window 71 are bonded to each other with a pressure sensitive adhesive sheet 11 interposed therebetween.

The pressure sensitive adhesive sheet of the present invention may be used for bonding any members. The image display device shown in FIG. 2 includes four pressure sensitive adhesive sheets 11, 12, 13 and 14, and it is preferable that one or more of these pressure sensitive adhesive sheets are the pressure sensitive adhesive sheet of the present invention. All of the pressure sensitive adhesive sheets 11, 12, 13 and 14 may be the pressure sensitive adhesive sheets described above. When two or more of the pressure sensitive adhesive sheets used for bonding the flexible members are the pressure sensitive adhesive sheet of the present invention, the thicknesses, physical properties, compositions and the like of the pressure sensitive adhesive sheets may be the same or different.

The order of bonding is not particularly limited. The touch panel 41, the circularly polarizing plate 31 and the cover window 71 may be laminated in this order on the image display panel 51, or a laminate obtained by laminating two or more flexible members beforehand with the pressure sensitive adhesive sheet interposed therebetween may be bonded onto the image display panel 51.

When two flexible members are bonded to each other using the pressure sensitive adhesive sheet 11, it is preferable that the release film (light-release film) 91 temporarily attached on one surface of the pressure sensitive adhesive sheet 11 is peeled off, the exposed surface of the pressure sensitive adhesive sheet 11 is then bonded to one member (first adherend), the other release film 92 (heavy-release film) is then peeled off, and the exposed surface of the pressure sensitive adhesive sheet is bonded to the other member (second adherend), from the viewpoint of bonding operability or the like. After the bonding, heating/pressurization treatment using an autoclave, and the like may be performed.

[Pressure Sensitive Adhesive Layer-Equipped Film]

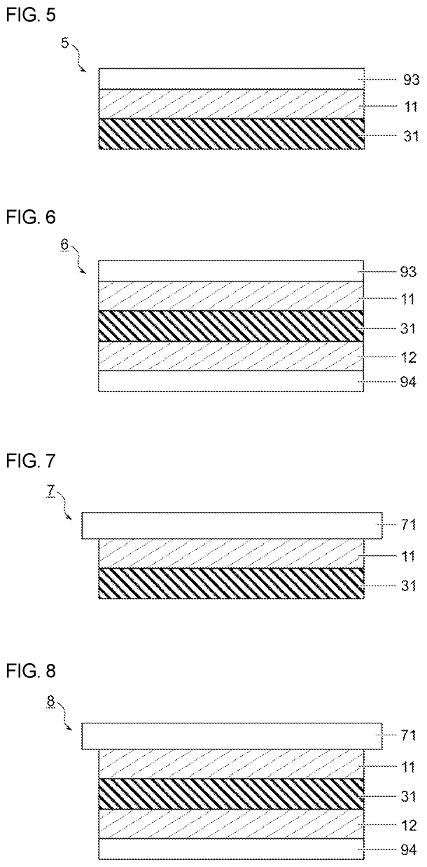

In addition to the form in which a release film is temporarily attached on each of both surfaces of the pressure sensitive adhesive layer, the pressure sensitive adhesive sheet of the present invention can be provided as a pressure sensitive adhesive layer-equipped film or a laminate in which a pressure sensitive adhesive sheet is firmly laminated on an optical film, etc., which may be used for formation of an image display device. For example, as in the pressure sensitive adhesive layer-equipped optical film 5 as shown in FIG. 5, the release film 93 is temporarily attached on one surface of the pressure sensitive adhesive sheet 11, and the circularly polarizing plate 31 is firmly laminated on the other surface of the pressure sensitive adhesive sheet 11. In the embodiment shown in FIG. 6, the pressure sensitive adhesive sheet 11 is firmly laminated on one surface of the circularly polarizing plate 31, and the pressure sensitive adhesive sheet 12 is firmly laminated on the other surface of the circularly polarizing plate 31. In the both sides pressure sensitive adhesive layer-equipped film 6, it is preferable that the release films 93 and 94 are temporarily attached on the surfaces of the pressure sensitive adhesive sheets 11 and 12, respectively, as shown in FIG. 6.

In an embodiment in which a polarizing plate or the like is laminated on a pressure sensitive adhesive sheet beforehand, one release film 93 temporarily attached on a surface of the pressure sensitive adhesive sheet 11 is peeled off, and bonded to an adherend (e.g. touch panel 41), and the other release film 94 is peeled off, and bonded to another adherend (e.g. cover window). When flexible members that form the image display device are bonded to the pressure sensitive adhesive sheets beforehand, the process for forming the image display device can be simplified.

In the both sides pressure sensitive adhesive layer-equipped film shown in FIG. 6, the thickness of the pressure sensitive adhesive sheet 11 laminated on one surface of the polarizing plate 31 may be the same as or different from the thickness of the pressure sensitive adhesive sheet 12 laminated on the other surface of the polarizing plate 31. For example, when the pressure sensitive adhesive sheet 12 is used for bonding the polarizing plate 31 to the touch panel or the image display panel, and the pressure sensitive adhesive sheet 11 is used for bonding the polarizing plate 31 to the front window 71, the thickness of the pressure sensitive adhesive sheet 11 is preferably 25 to 100 μm, and the thickness of the pressure sensitive adhesive sheet 12 is preferably 15 to 50 μm. In addition, the thickness of the pressure sensitive adhesive sheet 11 is preferably larger than the thickness of the pressure sensitive adhesive sheet 12.

The thickness of the release film 93 temporarily attached on the surface of the pressure sensitive adhesive sheet 11 may be the same as or different from the thickness of the release film 94 temporarily attached on the surface of the pressure sensitive adhesive sheet 12. Since the pressure sensitive adhesive sheet of the present invention has small G′ and is soft, the pressure sensitive adhesive sheet is easily deformed by an external impact during transportation or handling. Thus, it is preferable that the thickness of the release film is increased to prevent deformation of the pressure sensitive adhesive sheet due to an external impact or the like. In particular, the larger the thickness of the pressure sensitive adhesive sheet, the more easily deformation occurs due to an external impact, and therefore it is preferable to increase the thickness of the release film.

For example, the thickness of the release film 93 temporarily attached on the surface of the 25 to 100 μm-thick pressure sensitive adhesive sheet 11 is preferably 45 μm or more, more preferably 60 μm or more, further preferably 70 μm or more, especially preferably 80 μm or more. The thickness of the release film 94 temporarily attached on the surface of the 15 to 50 μm-thick pressure sensitive adhesive sheet 12 is preferably 30 μm or more, more preferably 35 μm or more, further preferably 40 μm or more. The thickness of the release film 93 is preferably larger than the thickness of the release film 94.

As with laminate 7 shown in FIG. 7, a plurality of members that form the image display device may be bonded together with the pressure sensitive adhesive sheet interposed between the members to form a laminate. FIG. 7 shows an example in which the cover window 71 is bonded to the circularly polarizing plate 31 with the pressure sensitive adhesive sheet 11 interposed therebetween. The laminate may be one in which other flexible members that form the image display device are laminated with the pressure sensitive adhesive sheet interposed between the members.

In FIG. 7, the size of the cover window 71 is larger than the size of the circularly polarizing plate 31, and the cover window 71 is disposed so as to protrude outside the end surface of the circularly polarizing plate 31. The cover window 71 and the circularly polarizing plate 31 may have the same size and shape. The size of the circularly polarizing plate 31 may be larger than the size of the cover window 71.

A laminate in which three or more flexible members are laminated may be formed using two or more pressure sensitive adhesive sheets. As shown in FIG. 8, the pressure sensitive adhesive sheet 12 may be further provided on the surface of the laminate. When the pressure sensitive adhesive sheet 12 is laminated on the surface of the laminate, the release film 94 may be temporarily attached on the surface of the pressure sensitive adhesive sheet 12.

In a pressure sensitive adhesive layer-equipped film and a laminate shown in FIGS. 5 to 8, the end surface of the pressure sensitive adhesive sheet may be positioned inside with respect to the end surfaces of the flexible member and/or the release film as adherends as in the form shown in FIGS. 3 and 4.

### EXAMPLES

Hereinafter, the present invention will be further described with reference to Examples and Comparative Examples, but the present invention is not limited to the following Examples.

[Preparation of Acrylic Oligomer]

<Oligomer A>

60 parts by weight of dicyclopentanyl methacrylate (DCPMA) and 40 parts by weight of methyl methacrylate (MMA) as monomer components, 3.5 parts by weight of α-thioglycerol as a chain-transfer agent, and 100 parts by weight of toluene as a polymerization solvent were mixed, and stirred in a nitrogen atmosphere at 70° C. for 1 hour. 0.2 parts by weight of 2,2′-azobisisobutyronitrile (AIBN) is added as a thermopolymerization initiator, and the mixture was reacted at 70° C. for 2 hours, then heated to 80° C., and reacted for 2 hours. Thereafter, the reaction liquid was heated to 130° C., and toluene, the chain-transfer agent and unreacted monomers were removed by drying to obtain a solid acrylic oligomer (oligomer A). The acrylic oligomer A had weight average molecular weight of 5,100 and glass transition temperature (Tg) of 130° C.

<Oligomer B>

Except that the monomer components were changed to 60 parts by weight of dicyclohexyl methacrylate (CHMA) and 40 parts by weight of butyl methacrylate (BMA), the same procedure as in preparation of the oligomer A was carried out to obtain a solid acrylic oligomer (oligomer B). The weight average molecular weight of the oligomer B was 5,000, and the glass transition temperature (Tg) was 44° C.

### Example 1

(Polymerization of Prepolymer)

35 parts by weight of lauryl acrylate (LA), 49 parts by weight of 2-ethylhexyl acrylate (2EHA), 7 parts by weight of 4-hydroxybutyl acrylate (4HBA) and 9 parts by weight of N-vinyl-2-pyrrolidone (NVP) as prepolymer-forming monomer components, and 0.015 parts by weight of “IRGACURE 184” (manufactured by BASF SE) as a photopolymerization initiator were blended, and the mixture was irradiated with an ultraviolet ray to perform polymerization, thereby obtaining a prepolymer composition (polymerization ratio: about 10%).

(Preparation of Pressure Sensitive Adhesive Composition)

To 100 parts by weight of the prepolymer composition, 0.07 parts by weight of 1,6-hexanediol diacrylate (HDDA), 3 parts by weight of the oligomer A and 0.3 parts by weight of a silane coupling agent (“KBM403” manufactured by Shin-Etsu Chemical Co., Ltd.) were added as post-addition components. The mixture was then uniformly mixed to prepare a pressure sensitive adhesive composition.

(Preparation of Pressure Sensitive Adhesive Sheet)

A 75 μm-thick polyethylene terephthalate (PET) film (“DIAFOIL MRF75” manufactured by Mitsubishi Chemical Corporation) having a silicone-based release layer on a surface thereof was provided as a substrate (also serving as heavily peelable film), and the photocurable pressure sensitive adhesive composition was applied in a thickness of 50 μm to form a coating layer on the substrate. To the coating layer, a 75 μm-thick PET film (“DIAFOIL MRE75” manufactured by Mitsubishi Chemical Corporation) with one surface subjected to silicone release treatment was bonded as a cover sheet (also serving as lightly peelable film). The laminate was irradiated with an ultraviolet ray from a black light to be photocured, thereby obtaining a pressure sensitive adhesive sheet having a thickness of 50 μm. The position of the black light was adjusted such that the irradiation intensity at an irradiation surface just below the lamp was 5 mW/cm².

### Examples 2 to 7 and Comparative Examples 1 to 10

The composition of the monomers in polymerization of the prepolymer, the amount of the polyfunctional monomer (HDDA), the type and the amount of the oligomer were changed as shown in Table 1. In the same manner as in Example 1 except for the above changes, the photocurable pressure sensitive adhesive composition was prepared, applied onto the substrate, and photocured to obtain a pressure sensitive adhesive sheet.

[Evaluation]

<Gel Fraction>

0.2 g of the pressure sensitive adhesive was collected from the pressure sensitive adhesive sheet. The sample was wrapped in a porous polytetrafluoroethylene film having pore diameter of 0.2 μm (manufactured by Nitto Denko Corporation; trade name: “NTF-1122”) cut to a size of 100 mm×100 mm, and the wrapped opening was tied with a kite string. The total weight (A) of the porous polytetrafluoroethylene film and the kite string measured beforehand was subtracted from the weight of this sample to calculate the weight (B) of the pressure sensitive adhesive sample. The pressure sensitive adhesive sample wrapped in the porous polytetrafluoroethylene film was immersed in approximately 50 mL of ethyl acetate at 23° C. for 7 days to elute sol components of the pressure sensitive adhesive to the outside of the polytetrafluoroethylene film. After immersion, the pressure sensitive adhesive wrapped in the porous polytetrafluoroethylene film was taken out, dried at 130° C. for 2 hours, and allowed to cool for about 20 minutes, and the dry weight (C) was measured. The gel fraction of the pressure sensitive adhesive was calculated from the following formula. gel fraction (%)=100×(C−A)/B

<Storage Elastic Modulus, Loss Tangent and Glass Transition Temperature>

Pressure sensitive adhesive sheets were stacked to a thickness of about 1.5 mm to prepare a sample for measurement. The dynamic viscoelasticity measurement was performed under the following conditions using “Advanced Rheometric Expansion System (ARES)” manufactured by Rheometric Scientific, Inc. The shear storage elastic modulus G′ and loss tangent tan δ in each of temperatures were determined from the measurement result. The temperature at which the tan δ was maximum was defined as a glass transition temperature of the pressure sensitive adhesive sheet.

(Measurement Conditions)

Deformation mode: torsion

Measurement Frequency: 1 Hz

Temperature elevation rate: 5° C./minute

Shape: parallel plate (7.9 mmφ)

<Total Light Transmittance and Haze>

The haze and the total light transmittance of a test piece obtained by bonding the pressure sensitive adhesive sheet to alkali-free glass (thickness: 0.8 to 1.0 mm, total light transmittance: 92%, haze: 0.4%) were measured using a haze meter (“HM-150” manufactured by MURAKAMI COLOR RESEARCH LABORATORY). A value obtained by subtracting the haze (0.4%) of the alkali-free glass from the measured value was defined as the haze of the pressure sensitive adhesive sheet. The measured value itself was taken as a total light transmittance. The total light transmittance of the pressure sensitive adhesive sheet of each of Examples and Comparative Examples was 92%. The haze of the pressure sensitive adhesive sheet of Example 5 was 0.7%, and the haze of the pressure sensitive adhesive sheet of each of the other Examples and the Comparative Examples was 0.3%.

<Adhesive Strength to Polyimide Film>

The release film on one surface was peeled from the pressure sensitive adhesive sheet, and the pressure sensitive adhesive sheet was bonded to a PET film having a thickness of 25 μm, and cut to a width of 10 mm and a length of 100 mm to obtain a test piece. The release film on the other surface was peeled from the test piece, and the pressure sensitive adhesive sheet was press-bonded to a 80 μm-thick transparent polyimide film (manufactured by KOLON Industries) using a 2 kg roller. Using a tensile tester, the test piece was peeled from the polyimide film under the condition of a peeling speed of 60 mm/minute and a peeling angle of 180° in an environment at 25° C. to measure the peeling strength.

<Bending Test>

The release film on one surface was peeled from the pressure sensitive adhesive sheet, a 51 μm-thick polarizing plate was bonded, the release film on the other surface was peeled, the pressure sensitive adhesive sheet was bonded to a 80 μm-thick transparent polyimide film, and press bonding was performed with a hand roller. This laminate was cut to a size of 50 mm×100 mm, and autoclaved at 35° C. and 0.35 MPa for 15 minutes to obtain a test piece. Using Tension-Free U-Shape Folding Tester (manufactured YUASA SYSTEM Co., Ltd.), a bending test was repeatedly conducted under the following conditions. In the repeated bending test, a bending jig was attached to the short sides of a test piece, and the polarizing plate-side surface of the test piece was set on the inner side in a thermostatic bath at −20° C. or 25° C.

(Test Conditions)

Bending radius: 3 mm

Bending angle: 180°

Bending speed: 1 second per bending

Bending frequency: 200,000 times

<Bending Retention Test>

The same test piece as in the bending test was used. The test was conducted with Tension-Free U-Shape Folding Tester. The polarizing plate-side surface of the test piece was set on the inner side, and the test piece was held in a thermohygrostat bath at 60° C. and a relative humidity of 95% while being maintained in a bent state with a bending radius of 3 mm and a bending angle of 180° for 240 hours.

The test piece after the repeated bending test (20° C. and 25° C.) and the test piece after the bending retention test were visually examined, and bending durability was evaluated in accordance with the following criteria. For samples rated NG for the repeated bending test result at 25° C., some of the evaluations were omitted.

OK: The polarizing plate and the polyimide film were not peeled from the pressure sensitive adhesive sheet, and ingress of bubbles into the adhesion interface did not occur;

Adhesiveness NG: The polarizing plate and/or the polyimide film were peeled from the pressure sensitive adhesive sheet; and

Bubbles NG: Bubbles remained at the adhesion interface.

[Evaluation Results]

The combination of pressure sensitive adhesive compositions used for preparation of each pressure sensitive adhesive sheet are shown in Table 1, and evaluation results are shown in Table 2. In Table 1, the components are represented by the following abbreviations.

LA: lauryl acrylate

2EHA: 2-ethylhexyl acrylate

BA: butyl acrylate

CHA: cyclohexyl acrylate

4HBA: 4-hydroxybutyl acrylate

2HEA: 2-hydroxyethyl acrylate

NVP: N-vinyl-2-pyrrolidone

TABLE 1

| | Prepolymer (base polymer) composition | | | | | | | Post-addition components | | |
|---|---|---|---|---|---|---|---|---|---|---|
| | LA | 2EHA | BA | CHA | 4HBA | 2HEA | NVP | HDDA | Oligomer A | Oligomer B |
| Example 1 | 35 | 49 | — | — | 7 | — | 9 | 0.07 | 3 | — |
| Example 2 | 40 | 50 | — | — | 4 | — | 6 | 0.07 | 3 | — |
| Example 3 | 43 | 44 | — | — | 6 | — | 7 | 0.07 | 1 | — |
| Example 4 | 43 | 44 | — | — | 6 | — | 7 | 0.07 | 3 | — |
| Example 5 | 43 | 44 | — | — | 6 | — | 7 | 0.07 | 5 | — |
| Example 6 | 43 | 44 | — | — | 6 | — | 7 | 0.09 | 3 | — |
| Example 7 | 50 | 35 | — | — | 7 | — | 8 | 0.07 | 3 | — |
| Example 8 | 60 | 22 | — | — | 8 | — | 10 | 0.06 | 3 | — |
| Comparative Example 1 | 43 | 44 | — | — | 6 | — | 7 | 0.07 | — | — |
| Comparative Example 2 | 43 | 44 | — | — | 6 | — | 7 | 0.07 | — | 3 |
| Comparative Example 3 | 43 | 44 | — | — | 6 | — | 7 | 0.12 | 3 | — |
| Comparative Example 4 | 60 | 22 | — | — | 8 | — | 10 | 0.04 | 3 | — |
| Comparative Example 5 | 60 | 22 | — | — | 8 | — | 10 | 0.15 | 3 | — |
| Comparative Example 6 | 22 | 60 | — | — | 8 | — | 10 | 0.09 | 3 | — |
| Comparative Example 7 | — | 82 | — | — | 8 | — | 10 | 0.09 | 3 | — |
| Comparative Example 8 | — | — | 57 | 12 | 23 | 8 | — | 0.13 | — | — |
| Comparative Example 9 | — | — | 99 | — | 1 | — | — | 0.15 | — | — |
| Comparative Example 10 | 79 | 20 | — | — | 1 | — | — | 0.30 | — | — |
| Comparative Example 11 | 99 | — | — | — | 1 | — | — | 0.30 | — | — |

TABLE 2

| | Pressure sensitive adhesive sheet properties | | | | | | | Evaluation of bonding |
|---|---|---|---|---|---|---|---|---|
| | Gel | | | | | | | Adhesive |
| | fraction | Tg | G′(kPa) | | Tan δ | | | strength |
| | (%) | (° C.) | 25° C. | 100° C. | 25° C. | 100° C. | difference | (N/10 mm) |
| Example 1 | 72 | −27 | 69 | 18 | 0.31 | 0.33 | −0.02 | 4.4 |
| Example 2 | 70 | −38 | 31 | 12 | 0.32 | 0.34 | −0.02 | 3.1 |
| Example 3 | 71 | −34 | 30 | 11 | 0.33 | 0.33 | 0.00 | 2.8 |
| Example 4 | 72 | −33 | 30 | 10 | 0.34 | 0.34 | 0.00 | 3.3 |
| Example 5 | 72 | −31 | 34 | 10 | 0.34 | 0.35 | −0.01 | 4.1 |
| Example 6 | 81 | −33 | 29 | 14 | 0.32 | 0.25 | 0.07 | 3.4 |
| Example 7 | 73 | −30 | 38 | 15 | 0.33 | 0.30 | 0.03 | 3.8 |
| Example 8 | 60 | −24 | 43 | 12 | 0.34 | 0.40 | −0.06 | 4.4 |
| Comparative Example 1 | 73 | −34 | 29 | 10 | 0.33 | 0.33 | 0.00 | 2.2 |
| Comparative Example 2 | 71 | −34 | 31 | 10 | 0.33 | 0.34 | −0.01 | 2.5 |
| Comparative Example 3 | 83 | −33 | 31 | 15 | 0.33 | 0.23 | 0.10 | 3.1 |
| Comparative Example 4 | 51 | −24 | 41 | 7 | 0.34 | 0.44 | −0.10 | 4.2 |
| Comparative Example 5 | 85 | −24 | 43 | 22 | 0.32 | 0.15 | 0.17 | 5.0 |
| Comparative Example 6 | 79 | −27 | 101 | 30 | 0.33 | 0.31 | 0.02 | 5.0 |
| Comparative Example 7 | 78 | −30 | 111 | 28 | 0.27 | 0.26 | 0.01 | 4.0 |
| Comparative Example 8 | 88 | −21 | 130 | 81 | 0.22 | 0.15 | 0.07 | 6.0 |
| Comparative Example 9 | 83 | −38 | 81 | 49 | 0.20 | 0.23 | −0.03 | 2.0 |
| Comparative Example 10 | 92 | −10 | 14 | 14 | 0.22 | 0.05 | 0.17 | 1.0 |
| Comparative Example 11 | 92 | 5 | 14 | 14 | 0.26 | 0.05 | 0.21 | 0.8 |

| | Evaluation of bonding | | |
|---|---|---|---|
| | | | Bending retention |
| | Repeated bending test | | test |
| | −20° C. | 25° C. | 60° C./95% RH |
| Example 1 | OK | OK | OK |
| Example 2 | OK | OK | OK |
| Example 3 | OK | OK | OK |
| Example 4 | OK | OK | OK |
| Example 5 | OK | OK | OK |
| Example 6 | OK | OK | OK |
| Example 7 | OK | OK | OK |
| Example 8 | OK | OK | OK |
| Comparative Example 1 | OK | OK | Adhesiveness NG |
| Comparative Example 2 | OK | OK | Adhesiveness NG |
| Comparative Example 3 | OK | OK | Adhesiveness NG |
| Comparative Example 4 | OK | OK | Bubbles NG |
| Comparative Example 5 | OK | OK | Adhesiveness NG |
| Comparative Example 6 | | Adhesiveness NG | OK |
| Comparative Example 7 | | Adhesiveness NG | OK |
| Comparative Example 8 | | Adhesiveness NG | |
| Comparative Example 9 | OK | OK | Adhesiveness NG |
| Comparative Example 10 | Adhesiveness NG | OK | Adhesiveness NG |
| Comparative Example 11 | Adhesiveness NG | OK | Adhesiveness NG |

For the pressure sensitive adhesive sheets of Examples 1 to 8, peeling did not occur after the test in either the repeated bending test at −20° C. and 25° C. or the bending retention test at 60° C. and 95% RH. Thus, these pressure sensitive adhesive sheets were suitable for bonding the members of bendable flexible displays. On the other hand, for the pressure sensitive adhesive sheets of Comparative Examples 1 to 11, peeling or remaining of bubbles occurred in any of the tests.

In Examples 3 to 6 and Comparative Examples 1 to 3, there was a difference in physical properties of the pressure sensitive adhesive sheet although there was no difference in ratio of monomers in the base polymer of the pressure sensitive adhesive. In Comparative Example 1 where the oligomer was not added, the adhesive strength to the polyimide film was low, so that peeling occurred after the bending retention test. In Comparative Example 2 where the oligomer B having a glass transition temperature of 44° C. was added, the adhesive strength was higher than that in Comparative Example 1, but peeling occurred after the bending retention test as in Comparative Example 1.

In Example 3 where the oligomer A having a glass transition temperature of 130° C. was added, the amount of the oligomer was smaller than that in Comparative Example 2, but adhesive strength higher than that in Comparative Example 2 was exhibited, and a bonding state between of the pressure sensitive adhesive sheet with the polarizing plate and the polyimide film was maintained even after the bending retention test. In Examples 4 and 5 where the amount of the oligomer was larger than that in Example 3, the adhesive strength tended to rise as the amount of the oligomer increased. These results indicate that by adding a high-Tg oligomer to an acryl-based base polymer in which a crosslinked structure is introduced, a pressure sensitive adhesive sheet can be obtained which is hardly delaminated near the bending position, and is excellent in bonding reliability.

Comparison among Examples 4 and 6 and Comparative Example 3 shows that the gel fraction increases with an increase in amount of HDDA which is a polyfunctional acrylate, and accordingly, tan δ₁₀₀ decreases, leading to an increase in difference between tan δ₁₀₀ and tan δ₂₅. Comparison among Example 8 and Comparative Examples 4 and 5 in which there was no difference in ratio of monomers in the base polymer shows the same tendency.

In Comparative Example 4 where the amount of HDDA was small, and the gel fraction of the pressure sensitive adhesive sheet was 51%, large tan δ₁₀₀ and good adhesiveness were exhibited, but air bubbles remained at the bonding interface after the bending retention test. In Comparative Example 4, it is considered that the resisting force against a pressure causing release of outgas from the film is low because tan δ is large at a high temperature and plastic deformation of the pressure sensitive adhesive sheet easily occurs.

In Example 1 where the ratio of lauryl acrylate, which is an acrylic acid long-chain alkyl ester, was small, larger G′₂₅ was obtained as compared to Examples 2 to 8. In Comparative Example 6 where the ratio of lauryl acrylate was smaller, G′ was larger as compared to Example 1, and peeling occurred at the interface between the polarizing plate and the pressure sensitive adhesive sheet after the repeated bending test at 25° C. In Comparative Example 7 where the base polymer did not contain lauryl acrylate as a monomer component, the pressure sensitive adhesive sheet had large G′, and peeling occurred after the repeated bending test as in Comparative Example 6.

The pressure sensitive adhesive sheet of Comparative Example 8 had high adhesive strength, but peeling occurred in the pressure sensitive adhesive sheet after the repeated bending test. In Comparative Example 8, it is considered that the pressure sensitive adhesive sheet had large G′₂₅, and therefore had a low strain-by-stress relaxation property, so that strain during bending was accumulated, resulting in occurrence of peeling.

In Comparative Examples 10 and 11 where the ratio of lauryl acrylate in the base polymer was increased, the pressure sensitive adhesive sheet had a high glass transition temperature, and had insufficient adhesive strength. In addition, in Comparative Examples 10 and 11, a large amount of the polyfunctional acrylate was added, and thus the pressure sensitive adhesive sheet had a large gel fraction, so that as in Comparative Examples 3 and 5, the bonding retention at a high temperature was low, resulting in occurrence of peeling after the bending retention test.

The above results indicate that when the pressure sensitive adhesive sheet has small G′ and thus is soft, and the temperature dependency of tan δ is adjusted, peeling and remaining of bubbles in repetition of bending and in maintenance of a bent state can be suppressed.

### DESCRIPTION OF REFERENCE SIGNS

11, 12, 13, 14 pressure sensitive adhesive sheet
91 release film (light-release film)
92 release film (heavy-release film)
93, 94 release film
1, 3, 4 release film-equipped pressure sensitive adhesive sheet
5, 6 pressure sensitive adhesive layer-equipped film
7, 8 optical laminate
31 optical film (circularly polarizing plate)
51 image display panel (OLED panel)
41 touch sensor
71 cover window
75 housing
100 image display device

1. A pressure sensitive adhesive sheet for bonding members of a bendable image display device, the pressure sensitive adhesive sheet comprising:
an acryl-based base polymer having a crosslinked structure; and
an acryl-based oligomer having a glass transition temperature of 60° C. or higher,
wherein the pressure sensitive adhesive has
a storage elastic modulus G′₂₅ of 5 to 75 kPa at 25° C. and 1 Hz,
a loss tangent tan δ₂₅ of 0.2 to 0.45 at 25° C. and 1 Hz,
a loss tangent tan δ₁₀₀ of 0.2 to 0.45 at 100° C. and 1 Hz,
a difference between the tan δ₂₅ and the tan δ₁₀₀ of −0.09 to 0.09, and
a glass transition temperature of −15° C. or lower.

2. The pressure sensitive adhesive sheet according to claim 1, wherein the pressure sensitive adhesive sheet has a storage elastic modulus G′₁₀₀ of 3 to 50 kPa at 100° C. and 1 Hz.

3. The pressure sensitive adhesive sheet according to claim 1, wherein the pressure sensitive adhesive sheet has a gel fraction of 55 to 85%.

4. The pressure sensitive adhesive sheet according to claim 1, wherein the acryl-based base polymer is a copolymer containing: 30 to 70 parts by weight of a (meth)acrylic acid C₁₀₋₂₀ chain alkyl ester; 15 to 60 parts by weight of a (meth)acrylic acid C₁₋₉ chain alkyl ester; and 5 to 25 parts by weight of one or more polar group-containing monomers selected from the group consisting of hydroxy group-containing monomers, carboxy group-containing monomers and nitrogen-containing monomers, based on 100 parts by weight of total monomer components.

5. The pressure sensitive adhesive sheet according to claim 4, wherein the acryl-based base polymer contains lauryl acrylate as the (meth)acrylic acid C₁₀₋₂₀ chain alkyl ester in the monomer components.

6. The pressure sensitive adhesive sheet according to claim 4, wherein the acryl-based base polymer contains a hydroxy group-containing monomer and a nitrogen-containing monomer as the polar group-containing monomers in the monomer components.

7. The pressure sensitive adhesive sheet according to claim 1, wherein the acryl-based base polymer has the crosslinked structure introduced with a polyfunctional (meth)acrylate.

8. The pressure sensitive adhesive sheet according to claim 1, wherein a content of the acryl-based oligomer is 0.5 to 10 parts by weight based on 100 parts by weight of the acryl-based base polymer.

9. The pressure sensitive adhesive sheet according to claim 1, wherein an adhesive strength of the pressure sensitive adhesive sheet to a polyimide film is 2.7 N/10 mm or more.

10. The pressure sensitive adhesive sheet according to claim 1, wherein the pressure sensitive adhesive sheet has a thickness of 10 to 150 μm.

11. A release film-equipped pressure sensitive adhesive sheet, comprising:
the pressure sensitive adhesive sheet according to claim 1;
a first release film temporarily attached on a first principal surface of the pressure sensitive adhesive sheet; and
a second release film temporarily attached on a second principal surface of the pressure sensitive adhesive sheet.

12. The release film-equipped pressure sensitive adhesive sheet according to claim 11, wherein an end surface of the pressure sensitive adhesive sheet is positioned inside with respect to an end surface of the first release film and an end surface of the second release film.

13. A pressure sensitive adhesive layer-equipped optical film, comprising:
an optical film;
a first pressure sensitive adhesive sheet laminated on a first principal surface of the optical film;
and a second pressure sensitive adhesive sheet laminated on a second principal surface of the optical film,
wherein at least one of the first pressure sensitive adhesive sheet and the second pressure sensitive adhesive sheet is the pressure sensitive adhesive sheet according to claim 1.

14. A pressure sensitive adhesive layer-equipped optical film, comprising:
an optical film;
a first pressure sensitive adhesive sheet laminated on a first principal surface of the optical film; and
a second pressure sensitive adhesive sheet laminated on a second principal surface of the optical film,
wherein each of the first pressure sensitive adhesive sheet and the second pressure sensitive adhesive sheet is the pressure sensitive adhesive sheet according to claim 1.

15. The pressure sensitive adhesive layer-equipped optical film according to claim 13, wherein the optical film includes a circularly polarizing plate.

16. A laminate comprising:
the pressure sensitive adhesive sheet according to claim 1;
a first member laminated on a first principal surface of the pressure sensitive adhesive sheet; and
a second member laminated on a second principal surface of the pressure sensitive adhesive sheet,
wherein each of the first member and the second member is bendable.

17. An image display device comprising a bendable image display panel, wherein two bendable members are bonded to each other with the pressure sensitive adhesive sheet according to claim 1 interposed therebetween.

18. An image display device comprising: a bendable image display panel; and a bendable cover window,
the image display device further comprising the pressure sensitive adhesive sheet according to claim 1 disposed between the image display panel and the cover window.

19. An image display device comprising: a bendable image display panel; and a bendable cover window,
the image display device further comprising a polarizing plate,
wherein the polarizing plate and the cover window are bonded to each other with the pressure sensitive adhesive sheet according to claim 1 interposed therebetween.
